(19) United States
(12) Patent Application Publication
(10) Pub. No.: US 2026/0329728 A1
(43) Pub. Date: Oct. 22, 2026

(54) Automated Debugging For Data Processing Platforms

(71) Applicant: Cribl, Inc., San Francisco, CA (US)

(72) Inventors: Roman Trusov, Foster City, CA (US); Bardhi Shtylla, Redwood City, CA (US); Ravinder James Singh Atwal, Seattle, WA (US); Monika Adriana Marko-Holguin, Aurora, IL (US)

(21) Appl. No.: 19/653,732

(22) Filed: Apr. 21, 2026

Related U.S. Application Data
(60) Provisional application No. 63/792,048, filed on Apr. 21, 2025.

(51) Int. Cl. G06F 11/362; G06F 16/3329

(52) U.S. Cl. CPC G06F 11/366; G06F 16/33295

(57) ABSTRACT

Based on an interaction with a user interface element of a user interface corresponding to a component of a data processing platform, a debug request associated with the component is received, the debug request including a component identifier (ID) corresponding to the component. From a log store and based on the component ID, error data associated with the component is obtained. A prompt for a large language model is generated based on the error data and metadata corresponding to the component. By processing the prompt with the large language model, a debug output including natural language textual instructions displayable in a user interface corresponding to the user interface element is provided.

### CROSS REFERENCE TO RELATED APPLICATIONS

This application claims the benefit of U.S. Provisional Patent Application Serial No. 63/792,048, filed Apr. 21, 2025, the entire disclosure of which is incorporated herein by reference.

### FIELD

The present disclosure relates to data processing platforms, and more particularly to automated debugging for data processing platforms.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a computing environment for automated debugging for data processing platforms.

FIG. 2 is a block diagram of an example internal configuration of a computing device.

FIG. 3 is a block diagram of an example of a computing environment for automated debugging for data processing platforms.

FIGS. 4A and 4B are diagrams of examples of data flows associated with automated debugging for data processing platforms.

FIGS. 5A and 5B are diagrams of example user interfaces associated with automated debugging for data processing platforms.

FIG. 6 is a flow diagram illustrating an example of a technique associated with automated debugging for data processing platforms.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, system, computer program product, non-transitory computer-readable medium, computing device, and/or processing system as described or substantially described herein with reference to and as illustrated by the drawings and the specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

Modern data processing platforms have become common in enterprise information technology (IT) infrastructures, providing a mechanism by which organizations may collect, process, and analyze vast amounts of data from diverse sources. These platforms typically consist of multiple interconnected components, including data ingestion tools, processing pipelines, search capabilities, and data storage solutions. By leveraging these technologies, businesses may gain valuable insights, improve operational efficiency, and make data-driven decisions.

One key feature of advanced data processing platforms is their ability to handle various data types and formats, including logs, metrics, traces, and security events. These platforms may offer both push and pull-based data ingestion methods, facilitating flexible data collection from a wide range of sources. Once data is ingested, it may be routed through processing pipelines that consist of a series of functions, each performing specific operations such as parsing, filtering, transforming, or enriching the data.

In addition to data processing capabilities, these platforms may include search and analytics tools that enable users to query and analyze data across multiple datasets. Some platforms incorporate artificial intelligence (AI)-assisted features to help users create queries, visualize data, and troubleshoot issues more efficiently. Furthermore, integrated data lake solutions may be available, providing long-term storage for full-fidelity data that may be easily searched or replayed as needed.

As these data processing platforms grow in complexity and scale, they often face challenges related to performance, reliability, and ease of use. It may be difficult to identify and resolve issues within the various components of the system, particularly when dealing with large-scale distributed deployments. The interconnected nature of these platforms means that problems in one area may have cascading effects throughout the system, making identifying the root cause(s) of the problems and resolving those root cause(s) a complex task.

One of the technical problems in operating data processing platforms is that issues may not be identified or resolved as quickly as needed to avoid unplanned downtime or that the troubleshooting or debugging process may utilize substantial compute, network, memory, power, and other resources. Such resources may also be wasted while certain components of the system are not functioning as intended. Such resources may be used more efficiently if the function of such components are restored or corrected more quickly. Traditional debugging approaches often require manual inspection of log files, which may be time-consuming and error-prone, especially when dealing with large-scale distributed systems. It is not possible for human operators to inspect the volume of log data typically generated by these platforms, making it challenging to pinpoint the root cause of problems efficiently. Furthermore, the interconnected nature of pipeline components means that errors in one part of the system may have cascading effects, further increasing the scope and context of the problem, complicating the debugging process.

A contributing technical factor is that existing data processing platform user interfaces do not maintain a programmatic linkage between a displayed component and the component's associated error entries in distributed log stores. When an operator observes a component error in the user interface, the operator must separately navigate to a logging system, manually construct queries using component identifiers, review the returned log entries, and then independently determine corrective action. No automated pipeline exists to bridge the gap between a user-interface-level observation of a component issue and the retrieval and analysis of that component's log data. This disconnection between the user interface layer and the log analysis layer is a structural limitation of prior platform architectures.

Implementations of this disclosure address problems such as these by providing an automated debugging pipeline that bridges a platform user interface to a log store and a machine learning component through a context-extraction mechanism. The system includes a user interface element associated with components of a data processing pipeline, providing a mechanism by which users may initiate a debug request with a single interaction. Upon receiving the debug request, the system obtains relevant error data from a log store based on a component identifier, generates a prompt for a machine learning (ML) component, and produces a debug output with natural language textual instructions. The steps of obtaining the relevant error data, generating the prompt and producing the debug output all may be initiated autonomously by the system.

As used herein, the term "component" includes any discrete functional unit within a data processing pipeline or platform. For example, a component may be a data ingestion tool, a processing function, a search capability, or a data storage solution. In some implementations, a component may also include a group of related functions or a subsystem within the larger data processing environment.

The "debug request" in this disclosure includes, but is not limited to, a user-initiated action to diagnose and/or resolve issues within a specific component of the data processing platform. The debug request may include a component identifier (ID), which uniquely identifies the component experiencing issues. In some implementations, the debug request may also include additional context information such as a product name or component name.

The system improves upon existing debugging approaches by automating the process of context gathering, log analysis, and solution generation. This technical solution involves real-time log querying, natural language processing, and dynamic user interface updates. The user interface element may be a button, link, or other interactive element contextually associated with the component being debugged.

In some implementations, the system may obtain context information based on an evaluation of user interface code. This may involve accessing a set of specified fields within the code to extract relevant metadata about the component and its environment. In some implementations, context gathering may include application programming interface (API) calls to a centralized configuration management system or analyzing real-time telemetry data from the component.

The extraction of context information by evaluating user interface code at runtime provides a technical advantage over conventional debugging approaches that may require users to manually identify and input component identifiers, names, or other metadata. By programmatically accessing specified fields within the document object model (DOM) elements or component properties of the user interface code, the system may automatically determine the identity and configuration of the component associated with the user interface element without requiring pre-configured metadata mappings or user input. The specified fields may include data attributes or properties embedded in the markup or component state of the user interface elements, such as a component identifier field (e.g., a "data-component-id" attribute or a "componentId" property), a component name field (e.g., a "data-component-name" attribute or a "componentName" property), and a product name field (e.g., a "data-product-name" attribute or a "productName" property). In implementations using a component-based user interface framework, these fields may be stored as properties of a component object or as entries in a component state store. This runtime introspection of the user interface code layer may reduce the risk of human error in identifying the correct component and may reduce the computational overhead of maintaining and querying a separate metadata registry.

In some implementations, the context information may be pre-computed when the user interface corresponding to the component is loaded or rendered, rather than being extracted at the time the debug request is initiated. For example, when a user navigates to a page displaying a component of the data processing platform, the user interface code may automatically extract the component ID, the component name, and the product name from the page's code and store these values in a local data structure accessible to the user interface element. When the user subsequently interacts with the user interface element to initiate a debug request, the pre-computed context information may be immediately included in the debug request without requiring additional extraction operations, thereby reducing the latency between the user interaction and the submission of the debug request.

The "prompt" generated for the ML component is an input that encapsulates the error data, component metadata, and any additional context information. This prompt is designed to elicit a relevant and actionable response from the ML component. In some implementations, the prompt may be dynamically constructed using a template system that adapts to different types of components and error scenarios.

An ML component refers to hardware and/or software capable of performing ML. ML is a subset of AI that involves the development of algorithms and statistical models providing a mechanism by which computers may perform tasks without explicit programming. ML leverages large datasets to identify patterns, make decisions, and improve over time based on experience. ML focuses on creating systems that may learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer may be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, large language models, other types of neural networks, classifiers, or decision trees, among other examples.

The "debug output" produced by the system includes natural language textual instructions to resolve the identified issue. These instructions may be presented as step-by-step procedures, explanations of root causes, or suggested configuration changes. In some implementations, the debug output may also include machine-readable instructions, a prompt, or combinations thereof that may be used to autonomously apply fixes or modifications to the affected component.

Some implementations of the system may include features such as integrating with version control systems to track changes made during debugging, providing collaborative debugging interfaces for multiple users, or incorporating feedback mechanisms to improve the accuracy of the ML-generated solutions over time. The system may also be extended to support debugging across multiple interconnected data processing pipelines or to provide predictive maintenance capabilities by analyzing patterns in historical debug requests and error data.

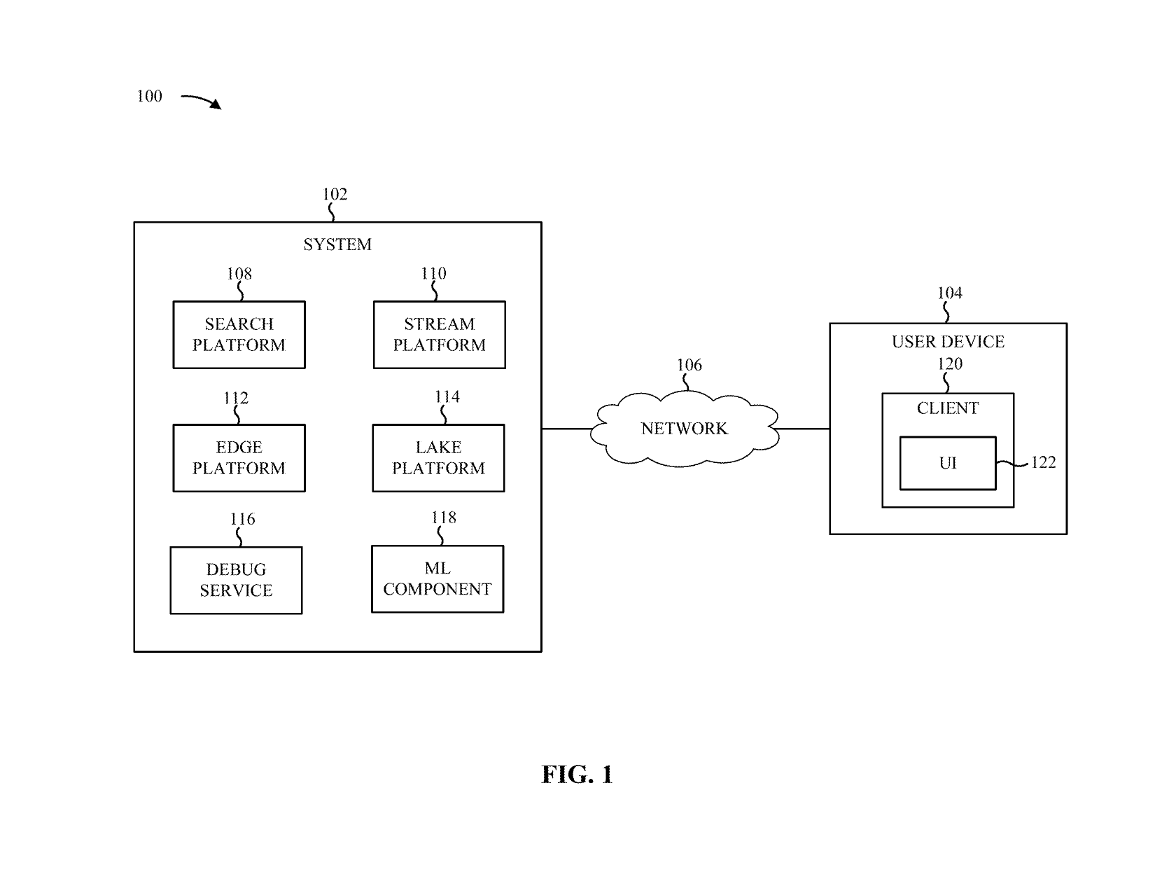

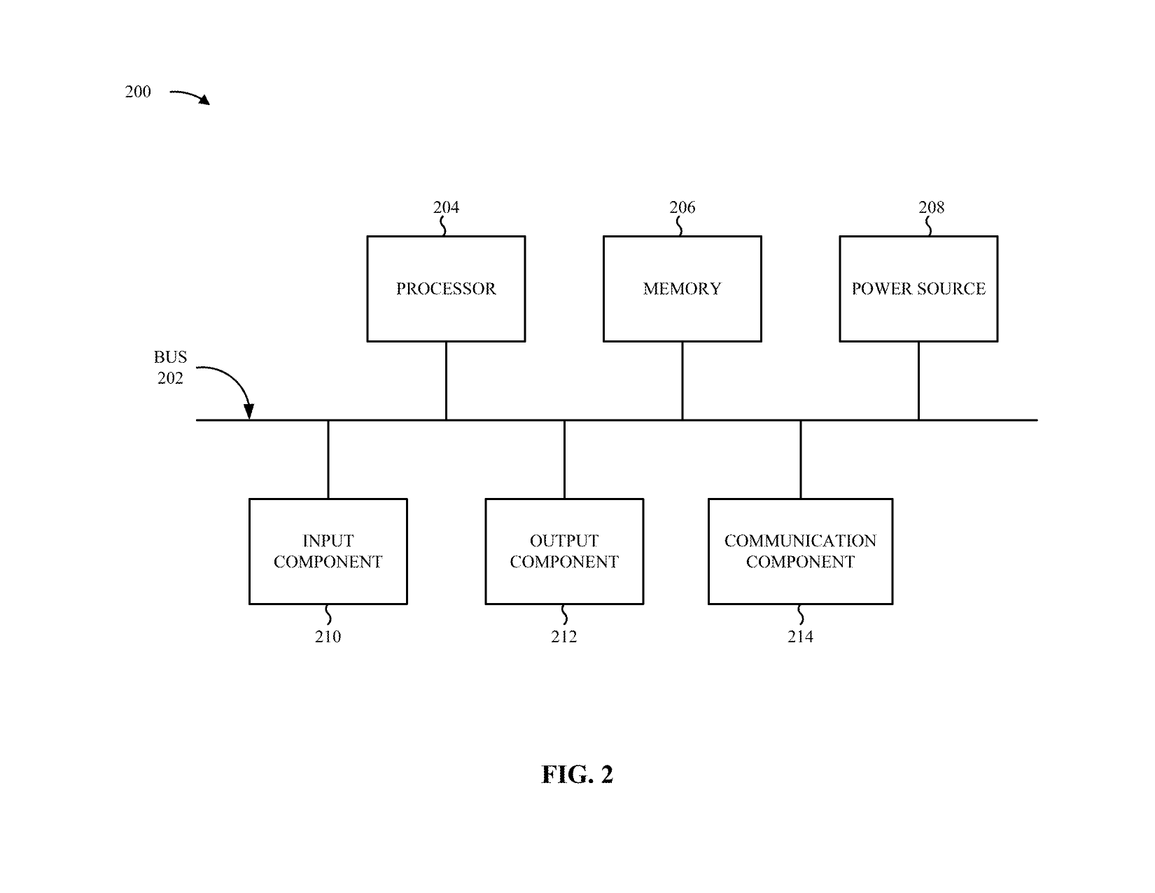

Further details of techniques for automated debugging for data processing platforms are described herein with initial reference to a system in which they may be implemented. FIG. 1 is a block diagram of an example of a computing environment 100 for providing automated debugging for data processing platforms. As shown, the computing environment 100 includes a system 102, a user device 104, and a network 106, which are configured to interact with each other to provide automated debugging capabilities for complex data processing environments. In some implementations, additional or fewer components may be included in the computing environment 100. The components and their arrangement within the computing environment 100 may implement the techniques disclosed herein for providing debugging for data processing pipelines and platforms. In some implementations, the system 102 may be implemented in a software as a service model, while in other implementations it may be implemented as a standalone system. In some implementations, the system 102 and the user device 104 may be implemented together on the same device. In some implementations, the system 102 and/or the user device 104 may be implemented using one or more computing devices, such as the computing device 200 illustrated in FIG. 2.

The system 102 may include one or more servers, virtual servers, machines, or virtual machines configured to perform the operations of the various components of the system 102. The system 102 includes one or more data processing platforms including, for example, a search platform 108, a stream platform 110, an edge platform 112, and a lake platform 114. The system 102 also includes a debug service 116 and an ML component 118. The search platform 108, the stream platform 110, the edge platform 112, the lake platform 114, the debug service 116, and the ML component 118 may include one or more interconnected components that perform various data processing and communication functions within the data processing platform. In some implementations, two or more of the search platform 108, the stream platform 110, the edge platform 112, the lake platform 114, the debug service 116, and the ML component 118 may be configured to share at least a portion of their processing or computing resources. For example, the system 102 may be implemented using one or more computing devices, such as the computing device 200, to which portions of the search platform 108, the stream platform 110, the edge platform 112, the lake platform 114, the debug service 116, and the ML component 118 have been distributed. In some implementations, the search platform 108, the stream platform 110, the edge platform 112, the lake platform 114, the debug service 116, and the ML component 118 may be implemented in software as a service (SaaS) model. In some implementations, one or more of the search platform 108, the stream platform 110, the edge platform 112, the lake platform 114, the debug service 116, and the ML component 118 may be implemented as dedicated standalone computing devices that are separate from one another. In some implementations, any of the search platform 108, the stream platform 110, the edge platform 112, the lake platform 114, the debug service 116, and the ML component 118 may be implemented using two or more computing devices (e.g., the computing device 200, as shown in FIG. 2). In some implementations, any of the search platform 108, the stream platform 110, the edge platform 112, the lake platform 114, the debug service 116, and the ML component 118 may be implemented using cloud-based computing devices (e.g., software as a service, infrastructure as a service, platform as a service, or another type of cloud-based service).

The system 102 may be in communication with the user device 104 via the network 106. The network 106 may be wired or wireless (e.g., Wi-Fi) and may include a local area network (LAN), wide area network (WAN) (e.g., the Internet), and/or an extranet. The user device 104 may be a computing device (e.g., the computing device 200, as shown in FIG. 2) that is configured to communicate with the system 102. For example, the user device 104 may be a desktop computer, a laptop computer, a smartphone, a tablet computer, a wearable computer, a server, a voice assistant device, or the like. The search platform 108, the stream platform 110, the edge platform 112, the lake platform 114, the debug service 116, and the ML component 118 may include respective user interfaces for interacting with the user device 104. In various implementations, the user device 104 may interact with any of the search platform 108, the stream platform 110, the edge platform 112, the lake platform 114, the debug service 116, and the ML component 118 via the network 106.

The search platform 108 may be configured to facilitate efficient querying and analysis of data across multiple datasets. Depending on the implementation, the search platform 108 may include search-in-place techniques that do not utilize or utilize limited indexing, indexing mechanisms, query parsers, and result aggregators, or combinations thereof to facilitate information retrieval. The search platform 108 may interface with other components of the system 102 to provide search capabilities during the debugging process.

The search platform 108 may be designed to explore data in place, without requiring data to be moved to specialized storage first. This capability provides a mechanism by which users may query logs, metrics, or any sort of machine data with less infrastructure overhead (e.g., indexing and associated storage). In some implementations, the search platform 108 may support a wide array of data sources, including data lakes, object stores, cloud data warehouses, analytics services and platforms, and application programming interface (API) endpoints. The search platform 108 may seamlessly integrate with other components of the system 102, such as the stream platform 110 and the edge platform 112, to provide a comprehensive data exploration solution.

The search platform 108 may generate queries in the required target query language for each underlying system. This abstraction layer may enable the search platform 108 to query data in place, using the specific language or technology associated with the data's storage location.

The search platform 108 may employ a distributed architecture to enhance performance and scalability. In some implementations, the search platform 108 may dynamically spin up multiple parallel search executors to facilitate the speed of searches. The search platform 108 may coordinate and federate results streaming in from multiple systems, interpret the results, and present a single, unified view of the result set. In some implementations, the search platform 108 may have the capability to extract structured field names and values even from unstructured source data, further enhancing its utility in complex data processing environments.

The stream platform 110 may be configured to execute and manage real-time data processing pipelines within the computing environment 100. In some implementations, the stream platform 110 may include components for data ingestion, transformation, or routing, among other examples.

The stream platform 110 may be designed to handle various data types and formats, including logs, metrics, traces, or security events, among other examples. In some implementations, the stream platform 110 may offer both push and pull-based data ingestion methods, facilitating flexible data collection from a wide range of sources. Once data is ingested, it may be routed through processing pipelines that consist of a series of functions, each performing specific operations such as parsing, filtering, transforming, or enriching the data. The stream platform 110 may utilize a routing table to evaluate incoming events against filter expressions, determining the appropriate pipeline for processing.

In some aspects, the stream platform 110 may include pre-processing, processing, and post-processing pipeline capabilities. Pre-processing pipelines may be attached to sources to condition or normalize events before they are delivered to processing pipelines. Processing pipelines may be the core event processing pipelines attached directly to routes. Post-processing pipelines may be attached to destinations to normalize events before they are sent out. The stream platform 110 may allow users to configure these pipelines through a graphical user interface or by importing JavaScript object notation (JSON) configurations. In some implementations, the stream platform 110 may support the use of function groups to streamline complex pipeline displays and improve organization.

The stream platform 110 may also include features for managing data output to various destinations. In some cases, the stream platform 110 may support both streaming and non-streaming destinations, with the ability to handle backpressure events when destinations are unreachable. The stream platform 110 may offer options for blocking, dropping, or queuing data when faced with destination issues. In some implementations, the stream platform 110 may provide load balancing capabilities for certain destinations, enhancing distribution efficiency. In some implementations, the stream platform 110 may support the use of persistent queues to reduce data loss and facilitate reliable data delivery, even in scenarios where destinations experience temporary outages or performance issues.

The edge platform 112 is designed to handle data processing and analysis at the network edge, closer to the data sources. In some implementations, the edge platform 112 may include lightweight processing units and local caching mechanisms to reduce latency and bandwidth usage. The edge platform 112 may communicate with the stream platform 110 and the lake platform 114 to facilitate edge-based data collection for logs, metrics, or application data.

The edge platform 112 may be designed to operate on various types of endpoints, including servers, cloud or datacenter virtual machines, and container nodes such as Amazon ECS instances or Kubernetes nodes. In some implementations, the edge platform 112 may utilize a lightweight package of core components, often referred to as an edge node, which may be deployed directly on customer endpoints. This approach may allow for efficient data collection and initial processing at the source, reducing the volume of data that needs to be transmitted to the stream platform 110.

The edge platform 112 may include capabilities for collecting data from local filesystems, APIs, and system states on the endpoints where it is deployed. In some cases, the edge platform 112 may offer processing, routing, and distribution functionalities similar to those found in the stream platform 110, but optimized for lower overall volume and reduced resource requirements at the endpoint level.

In some implementations, the edge platform 112 may support the creation of edge fleets, which are collections of edge nodes that may be managed centrally. The edge platform 112 may include features for fleet management, providing a mechanism by which administrators may configure, update, and monitor multiple edge nodes from a centralized control plane. This capability may enable organizations to efficiently manage large-scale deployments of edge processing units across diverse environments. The edge platform 112 may also integrate with the search platform 108, potentially providing a mechanism by which distributed search queries may be executed directly on edge nodes, further reducing the need to transfer large volumes of data to centralized systems for analysis.

The lake platform 114 provides long-term storage and management capabilities for large volumes of diverse data. In some implementations, the lake platform 114 may utilize distributed storage systems and support various data formats to accommodate the heterogeneous nature of data processed within the computing environment 100. The lake platform 114 may interact with the search platform 108 to enable comprehensive historical analysis during debugging operations.

The lake platform 114 may be designed to provide a scalable and flexible data storage solution that complements the real-time processing capabilities of the stream platform 110 and the edge platform 112. In some implementations, the lake platform 114 may utilize object storage technologies to create a centralized repository for long-term data retention. This approach may allow organizations to store large volumes of raw, unprocessed data in its original format, preserving the full fidelity of the information for future analysis and replay.

The lake platform 114 may organize data into datasets, which may be customized based on various criteria such as data source, type, or business unit. In some aspects, the lake platform 114 may support both built-in and custom datasets, providing flexibility in how data is structured and accessed. The data stored in the lake platform 114 may be compressed and stored in open, non-proprietary formats such as JSON, which may help reduce storage costs and avoid vendor lock-in. Additionally, the lake platform 114 may include features for data lifecycle management, providing a mechanism by which administrators may set retention policies and archive or delete data based on predefined rules.

In some implementations, the lake platform 114 may integrate closely with the search platform 108, providing a mechanism by which users may perform complex queries and analytics on historical data without the need for data movement or transformation. This integration may allow for seamless data exploration across both real-time and historical datasets, providing a comprehensive view of an organization's data landscape. The lake platform 114 may also support data replay functionality, providing a mechanism by which users may reprocess historical data through the stream platform 110 or send it to other destinations for further analysis or compliance purposes. This capability may be particularly useful for debugging, testing new data processing pipelines, or recovering from data loss in downstream systems.

The system 102 also includes a debug service 116, which serves as a manager for the automated debugging process. In some implementations, the debug service 116 may contain components for context gathering, log analysis, or solution generation, among other examples. The debug service 116 may interface with any of the other components of the system 102 to collect relevant information and coordinate a debugging workflow.

The debug service 116 may be designed to streamline and automate the process of identifying and resolving issues within the data processing platform. In some implementations, the debug service 116 may be configured to gather relevant information about the component being debugged, such as the component ID, product name, and component type. This context information may be obtained by evaluating user interface code or accessing specified fields within the system configuration.

The debug service 116 may incorporate a query builder that constructs targeted search queries based on the extracted context. These queries may be designed to efficiently retrieve relevant error data from the log store, focusing on specific time ranges, error levels, or component identifiers. In some cases, the debug service 116 may be configured to identify and extract error messages displayed in the user interface, incorporating them into the debugging process. The debug service 116 may utilize a prompt builder to generate structured inputs for the ML component 118, combining the gathered context, error data, and any additional metadata to create comprehensive prompts for analysis.

In some implementations, the debug service 116 may process the output from the ML component, converting it into user-friendly, step-by-step instructions for resolving the identified issues. The debug service 116 may support integration with version control systems, providing a mechanism by which it may track changes made during debugging sessions and potentially implement automated fixes based on the generated recommendations.

The ML component 118 is integrated within the system 102 to provide advanced analytical capabilities for the debugging process. In some implementations, the ML component 118 may be or include any number of models such as, for example, a natural language processing (NLP) model, a large language model (LLM), or a neural network, among other examples. In some implementations, the ML component 118 may be trained using ML techniques. For example, ML techniques may include supervised ML techniques, semi-supervised ML techniques, or unsupervised ML techniques. In some implementations, the ML component 118 may be trained using reinforcement learning algorithms. In some implementations, the ML component 118 or one or more aspects thereof may be implemented external to the system 102. For example, in some implementations, the ML component 118 may be maintained by an entity other than an entity that maintains the system 102. For example, the ML component 118 may include a commercially-available LLM or LLM platform.

In some implementations, the ML component 118 may utilize ML models, including LLMs, to analyze error patterns, generate insights, and propose solutions. The ML component 118 may work closely with the debug service 116 to enhance the accuracy and efficiency of the debugging process.

In some implementations, the ML component 118 may be fine-tuned on documentation specific to the data processing platform, including product documentation, configuration guides, troubleshooting manuals, and known issue databases. Fine-tuning the ML component 118 on platform-specific documentation may improve the relevance and accuracy of the debug output by incorporating domain-specific knowledge about the data processing platform's components, configuration parameters, error patterns, and resolution procedures. This domain-specific training may provide a mechanism by which the ML component 118 may generate actionable debugging instructions from concise prompts containing a limited set of error messages, without requiring extensive additional context. In other implementations, the ML component 118 may be a general-purpose ML model that has not been fine-tuned on platform-specific documentation.

In some implementations, the ML component 118 may serve a dual purpose in the debugging process. Firstly, it may analyze error patterns, system logs, and contextual information to identify potential debug solutions, generating human-readable recommendations for resolving issues within the data processing platform. Secondly, the ML component 118 may be capable of producing machine-readable instructions that may be used to facilitate the orchestration of error mitigation. These instructions may be in the form of scripts, configuration changes, or API calls that may be autonomously executed by the system to implement the suggested fixes. By leveraging natural language processing and code generation capabilities, the ML component 118 may translate its analysis into actionable steps that may be carried out either manually by system administrators or autonomously by the debug service 116. This approach may enable a more streamlined and efficient debugging process, potentially reducing downtime and minimizing the need for manual intervention in resolving complex system issues.

In operation, when a user encounters an issue within a data processing pipeline, they may interact with the user interface 122 on the client 120 to initiate a debug request. This request is transmitted through the network 106 to the system 102, where the debug service 116 coordinates the debugging process. The debug service 116 may query the search platform 108 for relevant log data, analyze the current state of the stream platform 110 and edge platform 112, and retrieve historical information from the lake platform 114.

The collected data is then processed by the ML component 118, which generates insights and potential solutions. These results are sent back through the network 106 to the user device 104, where they are presented in a user-friendly format via the user interface 122. In some implementations, the system 102 may also support interactive debugging sessions, providing a mechanism by which users may iteratively refine their queries and explore different aspects of the data processing pipeline.

In some implementations, the system 102 may include a mitigation process that follows the debugging and analysis phase. This mitigation process may involve autonomously applying fixes or configuration changes based on the recommendations generated by the ML component 118. The debug service 116 may coordinate with other components of the system 102 to implement these changes across the affected parts of the data processing pipeline. In some cases, the mitigation process may include a user approval step, where system administrators may review and authorize proposed changes before they are applied. The mitigation process may also involve creating backups or snapshots of the current system state before applying changes, facilitating easy rollback if unexpected issues arise. Additionally, the system 102 may log mitigation actions taken, providing a detailed audit trail for future reference and analysis. This automated mitigation capability may help reduce the time and effort required to resolve issues, potentially improving the overall reliability and performance of the data processing platform.

The system 102 may be extended to support collaborative debugging scenarios. In some implementations, multiple user devices 104 may connect to the system 102 simultaneously, providing a mechanism by which teams may work together on complex debugging tasks. The debug service 116 may incorporate version control mechanisms to track changes and maintain a history of debugging actions across multiple users.

In some implementations, the automated debugging capabilities of the system 102 may be extended to additional components or products of the data processing platform by deploying a user interface element and a corresponding context collector on each product page or component view that is to support debugging. Each context collector may be configured to extract a uniform set of context variables from the user interface code of its respective page, including a product name identifying the data processing platform product (e.g., the search platform 108, the stream platform 110, the edge platform 112, or the lake platform 114), a component name identifying the specific component being viewed, and a component ID uniquely identifying the component instance. By standardizing the context variables extracted across different product pages, the debug service 116 may process debug requests from any supported product using the same query construction, prompt generation, and ML analysis pipeline, without requiring product-specific debugging logic. This uniform interface pattern may provide a mechanism by which the automated debugging capabilities may be incrementally extended to new products or component types by adding a user interface element and context collector to the corresponding user interface page.

In this configuration, the system 102 orchestrates the automated debugging process for data processing platforms, facilitating rapid issue resolution and minimizing system downtime. The integration of advanced search capabilities, real-time data processing, edge computing, and ML facilitates comprehensive analysis and solution generation, thereby enhancing the overall reliability and performance of complex data processing environments.

FIG. 2 shows a block diagram of an example of a computing device 200 capable of performing functions described herein. The computing device 200 may be used to implement one or more components of the computing environment 100. The computing device 200 may be, be similar to, include, or be included in, an apparatus for performing one or more methods, processes, algorithms, operations, tasks, and/or techniques, as described herein. The computing device 200 may be, be similar to, include, or be included in, a computing device, a laptop, a workstation, a server device, or a personal computer, among other examples. The computing device 200 includes a bus 202 that interconnects various components or units, such as a processor 204, a memory 206, a power source 208, an input component 210, an output component 212, and a communication component 214, among other examples.

The processor 204 may be a central processing unit, such as a microprocessor, and may include single or multiple processors having single or multiple processing cores. The processor 204 may include another type of device, or multiple devices, configured for manipulating or processing information. For example, the processor 204 may include multiple processors interconnected in one or more manners, including hardwired or networked. The operations of the processor 204 may be distributed across multiple devices or units that may be coupled directly or across a local area or other suitable type of network. The processor 204 may include a cache, or cache memory, for local storage of operating data or instructions.

The memory 206 includes one or more memory components, which may each be volatile memory or non-volatile memory. The memory 206 may include non-transitory memory. The volatile memory may be random access memory (RAM) (e.g., a DRAM module, such as DDR SDRAM). The non-volatile memory of the memory 206 may be a disk drive, a solid state drive, flash memory, or phase-change memory. In some implementations, the memory 206 may be distributed across multiple devices. For example, the memory 206 may include network-based memory or memory in multiple clients or servers performing the operations of those multiple devices.

The memory 206 may include data for access by the processor 204. For example, the memory 206 may include executable instructions, application data, or an operating system, among other examples. The executable instructions may include one or more application programs, which may be loaded or copied, in whole or in part, from non-volatile memory to volatile memory to be executed by the processor 204. For example, the executable instructions may include instructions for performing techniques described in this disclosure. In some implementations, the application data may include functional programs, such as computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 may be an interface to an external power distribution system. In an example, the power source 208 may be a battery, such as where the computing device 200 is a mobile device or is otherwise configured to operate independently of an external power distribution system. In some implementations, the computing device 200 may include or otherwise use multiple power sources. In some such implementations, the power source 208 may be a backup battery.

The input component 210 and/or the output component 212 may include one or more input interfaces and/or output interfaces configured for facilitating communication between the computing device 200 and one or more peripheral devices such as, for example, one or more sensors, detectors, displays, input devices, or other devices configured for facilitating interaction with the computing device 200 or the environment around the computing device 200. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripheral devices may include a geolocation component, such as a global positioning system (GPS) location unit. In some examples, the peripheral devices may include a temperature sensor for measuring temperatures of components of the computing device 200, such as the processor 204.

The communication component 214 may include an interface for facilitating a connection or link to a network. The communication component 214 may include a wired network interface or a wireless network interface. The computing device 200 may communicate with other devices via the communication component 214 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 200 may communicate with a database server.

The communication component 214 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

An apparatus, computing device (e.g., the computing device 200), one or more components of a computing device, or a system, among other examples, described herein may include one or more chips, system-on-chips (SoCs), chipsets, packages, and/or devices that individually or collectively constitute or comprise a processing system. A processing system may include processor (or "processing") circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as "processors" or collectively as "processor" or "processor circuitry").

The terms "processor," "processing circuitry," "processing component," "processor component," "controller," or "controller/processor" may refer to one or more controllers and/or one or more processors. For example, reference to "a/the processor," "a/the controller/processor," or the like (in the singular) should be understood to refer to any one or more of the processors described in connection with FIG. 2, such as a single processor or a combination of multiple different processors. Reference to "one or more processors" should be understood to refer to any one or more of the processors described in connection with FIG. 2.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to "one or more memories" should be understood to refer to any one or more memories of a corresponding device, such as the memory described in connection with FIG. 2. For example, operation described as being performed by one or more memories may be performed by the same subset of the one or more memories or different subsets of the one or more memories. Additionally or alternatively, in some examples, one or more of the processors may be preconfigured to perform various functions or operations described herein without requiring configuration by software.

As used herein, the term "component" is intended to be broadly construed as hardware and/or a combination of hardware and software. "Software" shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code it being understood that software and hardware may be designed to implement the systems and/or methods based, at least in part, on the description herein.

An "engine" refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations and should generally not be limited to any particular implementation exemplified herein, unless such limitations are expressly called out. As used herein, the term "model" encompasses its plain and ordinary meaning. A model may include, among other things, one or more engines which receive an input and compute an output based on the input.

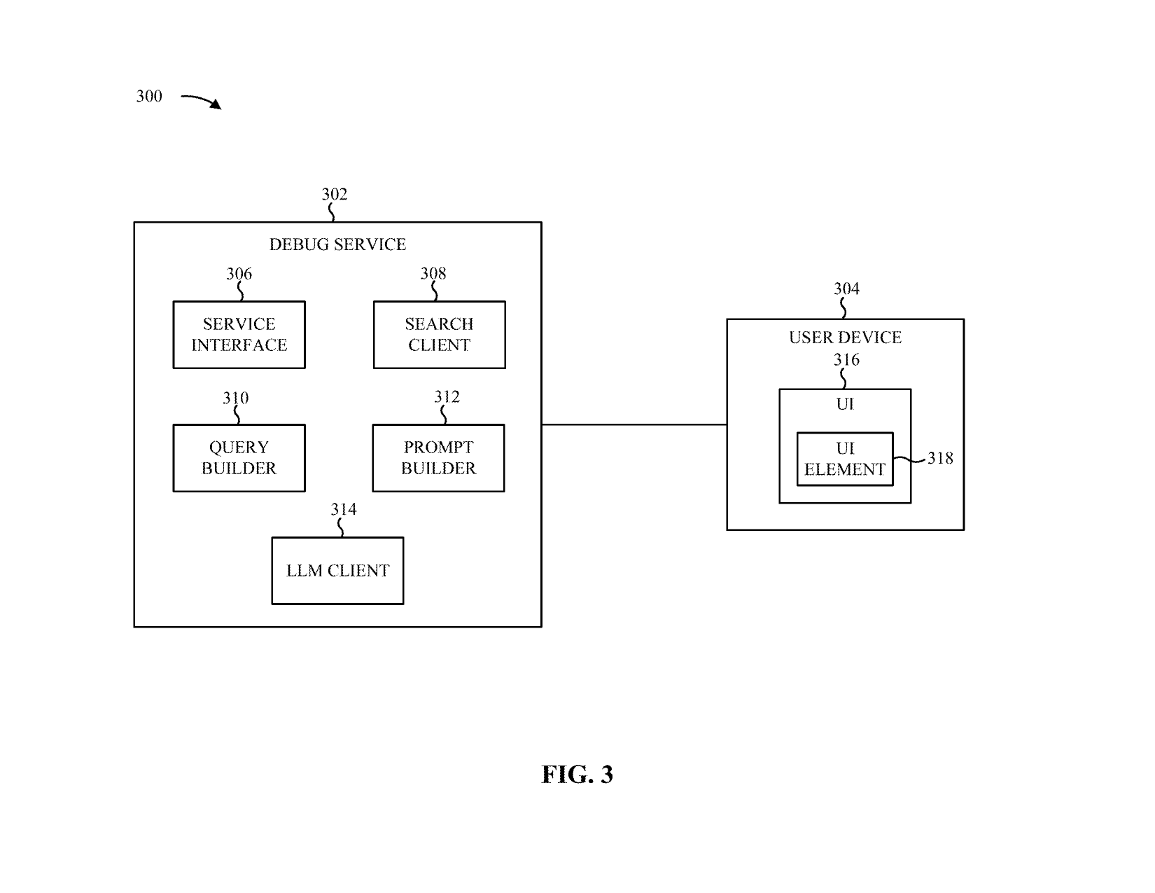

FIG. 3 is a block diagram of an example of a computing environment 300 for providing automated debugging for data processing platforms. As shown, the computing environment 300 includes a debug service 302 and a user device 304, which are configured to interact with each other to provide automated debugging capabilities for complex data processing environments. In some implementations, additional or fewer components may be included in the computing environment 300. The components and their arrangement within the computing environment 300 may implement the techniques disclosed herein for providing debugging for data processing pipelines and platforms. In some implementations, the debug service 302 may be, be similar to, include, or be included in, the debug service 116 of FIG. 1. In some implementations, the user device 304 may be, be similar to, include, or be included in, the user device 104 of FIG. 1.

In some implementations, the debug service 302 may include multiple interconnected subcomponents that work together to analyze and resolve issues within data processing pipelines. The debug service 302 includes a service interface 306, a search client 308, a query builder 310, a prompt builder 312, and an LLM client 314, each serving specific functions in the debugging workflow. In some implementations, two or more of the service interface 306, the search client 308, the query builder 310, the prompt builder 312, and the LLM client 314 may be included in a single component of the debug service 302. The debug service 302 may include any number of additional or different components to support the debugging process.

The service interface 306 acts as a communication channel between the debug service 302 and other components of the computing environment 300. In some implementations, the service interface 306 may be configured to receive debug requests from the user device 304 and coordinate the flow of information between various subcomponents of the debug service 302. The service interface 306 may utilize standardized protocols or APIs to facilitate integration with external systems and components. In some examples, the service interface 306 may be or include a software interface (such as the user interface (UI) 122 shown in FIG. 1) which provides a mechanism by which users may interact directly with the debug service 302. Additionally, in some examples, the service interface 306 may be a message-based interface which facilitates bidirectional communication between the debug service 302 and external systems. The service interface 306 may be implemented as a web-based interface, a graphical user interface, or another type of interface suitable for user interaction.

The search client 308 is configured to interact with log storage systems and retrieve relevant error data associated with the component being debugged. In some implementations, the search client 308 may support multiple query languages and storage backends, providing a mechanism by which it may interface with diverse logging infrastructures.

The search client 308 may be designed to efficiently retrieve and process large volumes of log data from various sources within the data processing platform. In some implementations, the search client 308 may employ distributed search techniques to parallelize queries across multiple log storage nodes, facilitating rapid retrieval of relevant error information even in high-scale environments. The search client 308 may also incorporate caching mechanisms to store frequently accessed log data or query results, potentially reducing response times for subsequent debug requests related to similar issues.

In some aspects, the search client 308 may include adaptive query optimization capabilities that analyze past search patterns and adjust query strategies accordingly. This may involve dynamically adjusting search parameters, such as time ranges or log levels, based on the context of the debug request and historical debugging data. The search client 308 may also support fuzzy matching algorithms, providing a mechanism by which it may identify relevant error data even when exact matches are not available. This flexibility may be particularly useful in scenarios where log formats or error messages have changed over time.

The search client 308 may integrate with various authentication and authorization systems to facilitate secure access to log data. In some implementations, the search client 308 may apply role-based access controls, such that users or processes may only retrieve log data for which they have appropriate permissions. In some implementations, the search client 308 may support data masking or redaction capabilities, providing a mechanism by which sensitive information may be filtered out of search results before they are returned to the debugging process. This may help maintain data privacy and compliance with regulatory requirements while still providing valuable debugging insights.

The search client 308 may work in conjunction with the query builder 310 to formulate and execute targeted search queries. The query builder 310 may be configured to construct efficient and accurate search queries based on the context provided in the debug request. In some implementations, the query builder 310 may employ algorithms to optimize query performance and relevance. The query builder 310 may take into account factors such as time ranges, error severity levels, and component-specific metadata to generate targeted queries.

The query builder 310 may incorporate ML techniques to enhance its query generation capabilities. In some implementations, the query builder 310 may utilize historical debugging data and user feedback to train models that predict the most effective query structures for different types of debug requests. This adaptive approach may allow the query builder 310 to continuously improve its performance over time, potentially reducing the number of iterations required to locate relevant error data.

In some aspects, the query builder 310 may support the creation of complex, multi-stage queries that may traverse multiple log sources or data stores. The query builder 310 may include logic to handle distributed data environments, where relevant information may be spread across different systems or geographical locations. In such cases, the query builder 310 may generate sub-queries for each data source and combine the results in a coherent manner. The query builder 310 may also incorporate query optimization techniques, such as query rewriting or predicate pushdown, to improve execution efficiency in distributed environments.

The query builder 310 may offer customization options to accommodate specific debugging workflows or organizational requirements. In some implementations, the query builder 310 may use query templates or rules when constructing queries. These customizations may include specifying preferred log fields, setting default time ranges, or defining component-specific query patterns. The query builder 310 may also support integration with external knowledge bases or configuration management systems, providing a mechanism by which it may incorporate additional context when generating queries. This flexibility may enable the query builder 310 to adapt to various debugging scenarios and organizational structures within a data processing platform such as the system 102.

The prompt builder 312 is designed to create structured inputs for ML components (e.g., the ML component 118 shown in FIG. 1) such as LLMs used in the debugging process. In some implementations, the prompt builder 312 may incorporate natural language processing techniques to transform raw error data and contextual information into well-formed prompts. These prompts are crafted to elicit relevant and actionable responses from the ML components involved in the debugging process.

The prompt builder 312 may utilize a template-based approach to construct prompts that are tailored to specific debugging scenarios. In some implementations, the prompt builder 312 may maintain a library of prompt templates that are designed to address various types of errors or issues commonly encountered in data processing pipelines. These templates may include placeholders for dynamic content such as error messages, component metadata, and relevant log excerpts. The prompt builder 312 may select an appropriate template based on factors such as the error type, component characteristics, and debugging context, then populate the template with specific information gathered from the error data and search results.

In some aspects, the prompt builder 312 may employ natural language understanding techniques to analyze error messages and log data, extracting key information and identifying relevant context. This analysis may help the prompt builder 312 to prioritize and structure the information included in the prompt, facilitating presenting pertinent details to the ML component in a clear and concise manner. The prompt builder 312 may also incorporate domain-specific knowledge about data processing pipelines and common debugging practices, providing a mechanism by which it may frame queries and provide context in a way that is likely to elicit useful responses from the ML component.

The prompt builder 312 may include mechanisms for iterative refinement of prompts based on the responses received from the ML component. In some implementations, if the initial debug output is insufficient or unclear, the prompt builder 312 may generate follow-up prompts that request clarification or additional details on specific aspects of the problem. This iterative approach may allow the debugging process to drill down into complex issues, potentially uncovering root causes that may not be immediately apparent from the initial error data. The prompt builder 312 may also learn from successful debugging sessions, updating its prompt generation strategies to improve the efficiency and effectiveness of future debugging interactions.

The LLM client 314 serves as an interface between the debug service 302 and external ML or LLM services. In some implementations, the LLM client 314 may support multiple ML components, facilitating flexibility in choosing an appropriate ML component for different debugging scenarios. The LLM client 314 may handle tasks such as authentication, request formatting, and response parsing when interacting with these ML services.

The user device 304 represents the endpoint through which users interact with the automated debugging system. In some implementations, the user device 304 may be a desktop computer, laptop, tablet, smartphone, or any other computing device capable of running the required user interface software. The user device 304 includes a user interface 316, which provides the visual and interactive elements necessary for initiating and managing debugging sessions.

The user interface 316 is a component of the user device 304, offering a graphical interface for users to interact with the automated debugging system. In some implementations, the user interface 316 may be a web-based application, a native desktop application, or a mobile app. The user interface 316 is designed to present complex debugging information in an intuitive manner, providing a mechanism by which both technical and non-technical users may leverage the system effectively.

Within the user interface 316, there is an interface element 318 specifically associated with initiating the automated debugging process. In some implementations, the interface element 318 may be a button, link, or other interactive UI component contextually placed near the representation of the data processing pipeline component being debugged. The interface element 318 serves as the entry point for users to trigger the automated debugging workflow.

In operation, when a user encounters an issue within a data processing pipeline, they may interact with the interface element 318 on the user interface 316 of the user device 304. This interaction generates a debug request, which is transmitted to the debug service 302 through the service interface 306. The debug service 302 then coordinates the debugging process by leveraging its various subcomponents.

The service interface 306 first passes the debug request to the query builder 310, which constructs an appropriate search query. This query is then executed by the search client 308 to retrieve relevant error data from the log storage systems. Concurrently, the prompt builder 312 may begin formulating a structured prompt based on the initial context provided in the debug request.

Once the error data is retrieved, the prompt builder 312 incorporates this information into the prompt, creating a comprehensive input for the ML component. The LLM client 314 then sends this prompt to the ML component, which processes the information and generates debugging insights or recommendations.

The debug service 302 receives the ML-generated output through the LLM client 314 and may perform additional processing or formatting. The service interface 306 then sends the final debug output back to the user device 304, where it is displayed in the user interface 316, providing the user with actionable steps to resolve the identified issue.

In some implementations, the computing environment 300 may support iterative debugging sessions, providing a mechanism by which users may refine their queries or provide additional context based on initial results. This iterative process may involve multiple rounds of communication between the user device 304 and the debug service 302, with each iteration potentially involving different subcomponents of the debug service 302 as needed.

The computing environment 300, as illustrated in FIG. 3, orchestrates the automated debugging process for data processing platforms, facilitating issue resolution and reducing system downtime. The integration of search capabilities, ML-powered analysis, and user interfaces facilitates comprehensive debugging that may be performed by users with varying levels of technical expertise, thereby enhancing the reliability and maintainability of complex data processing environments.

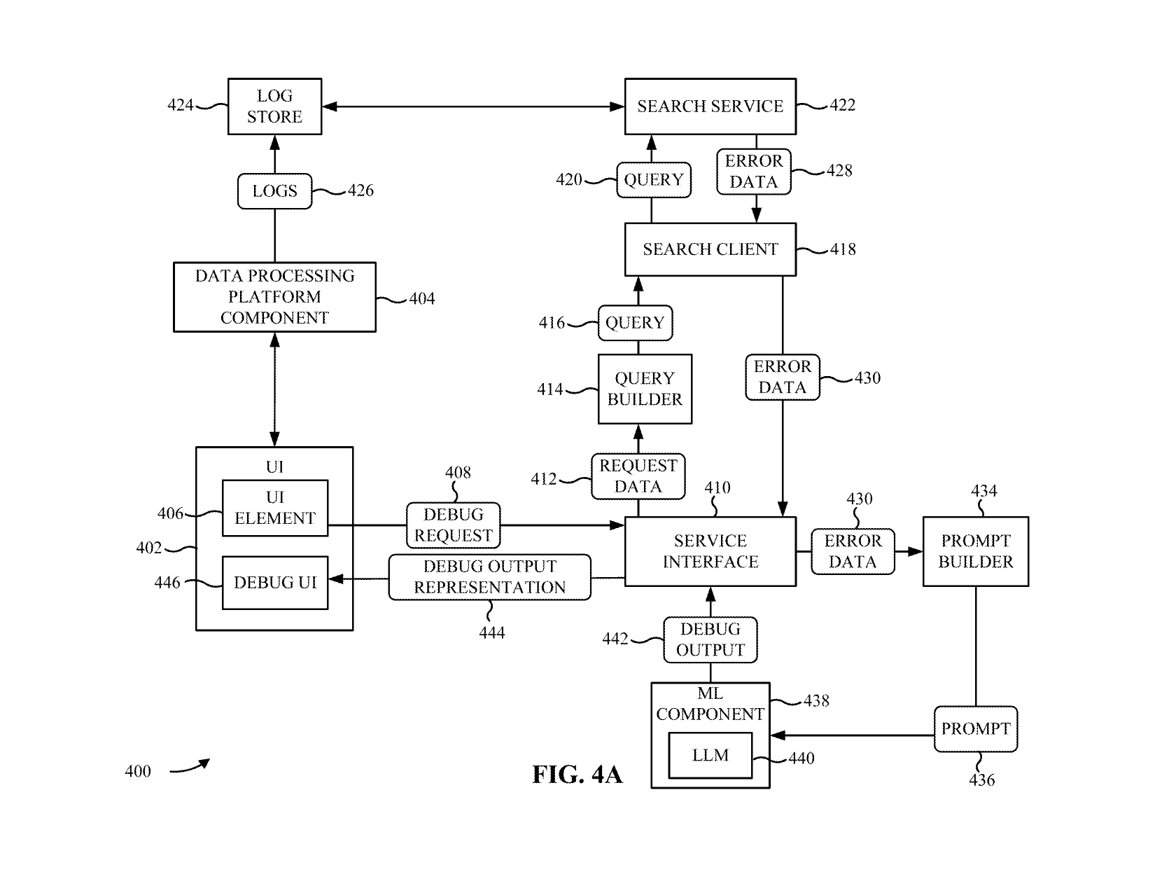

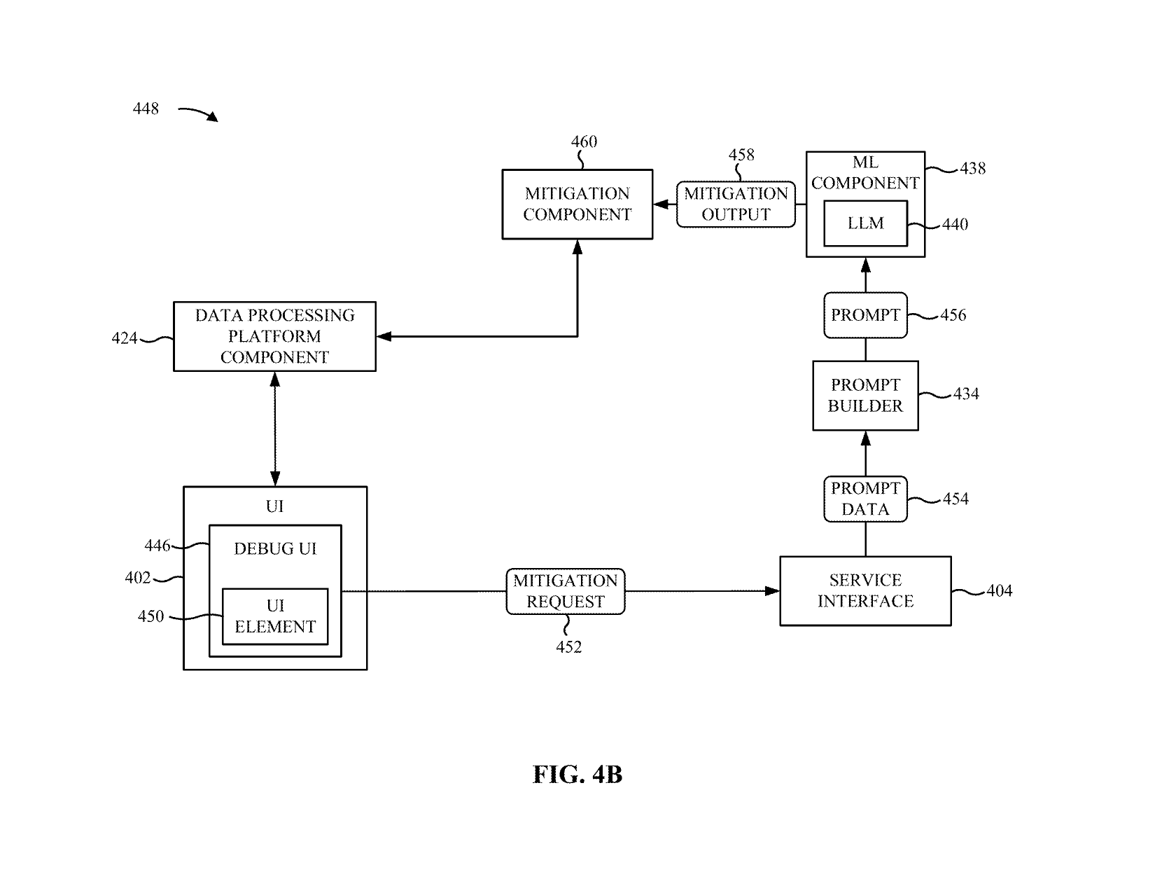

FIGS. 4A and 4B are diagrams of examples of data flows 400 and 448, respectively, associated with automated debugging for data processing platforms. In some implementations, one or more aspects of the data flows 400 and 448 may be performed by one or more components of the computing environment 100 shown in FIG. 1 or the computing environment 300 shown in FIG. 3.

FIG. 4A illustrates a data flow 400 for processing a debug request and generating a debug output. The data flow 400 includes a user interface 402 and a data processing platform component 404. In some implementations, the user interface 402 may be similar to or include the user interface 122 shown in FIG. 1 or the user interface 316 shown in FIG. 3. The data processing platform component 404 may be a component of a data processing platform such as the search platform 108, the stream platform 110, the edge platform 112, or the lake platform 114 shown in FIG. 1. A component of a data processing platform may include, for example, a feature, a service, a module, a user interface, a functionality, or a capability of the data processing platform, among other examples. For example, a component of a stream platform may include a component of a data processing pipeline.

The user interface 402 includes a user interface element 406, which may be contextually associated with a component of a data processing platform. In some implementations, the user interface element 406 may be a button, link, or other interactive element that provides a mechanism by which a user may initiate a debug request.

The user interface element 406 may be contextually associated with the data processing platform component 404 in various ways. In some implementations, the user interface element 406 may be positioned in close proximity to the visual representation of the component 404 within the user interface 402. In some implementations, the component 404 may have a corresponding user interface 402 may be presented by the user interface (e.g., may be a part of the user interface 402). In some implementations, the user interface element 406 may appear as a debug button or icon adjacent to or overlaid on the component's display area. In other aspects, the user interface element 406 may dynamically appear or become active when a user interacts with or selects the component 404. The contextual association may also refer to the functionality of the user interface element 406, where activating it may autonomously populate the debug request with relevant information about the selected component, such as its identifier, type, or current state. This contextual relevance may help streamline the debugging process by providing users with an intuitive and direct way to initiate debugging for specific components they are working with or examining within the data processing platform.

The user interface element 406 is an interactive element. For example, the user interface element 406 may be activated when a user places a cursor over the user interface element 406, clicks the user interface element 406, or otherwise makes a selection within the user interface 402 that includes the user interface element 406. The user interface element 406 may include a button, a hyperlink, a menu option, or a toggle, among other examples.

When a user interacts with the user interface element 406, a debug request 408 is autonomously generated (based on the user interaction e.g., in response to the user interaction) and sent to the data processing platform component 404. The debug request 408 includes context information (which may be referred to herein, interchangeably, as "context") that describes the component 404 and the issue that caused the user to interact with the user interface element 406. The context may include information related to the current state of the component 404, information related to the environment or environment instance in which the component 404 is operating, information related to the users who interact with the component 404, information related to the data processing platform component 404 on which the component 404 resides, or information related to the environment in which the component 404 exists. In some implementations, the context may include a component ID, a component name, and a product name associated with the component 404. The product name may refer to the data processing platform to which the data processing platform component corresponds. In some implementations, the context may include a component type associated with the component 404. In some implementations, the component may include a version of the component 404, where the version is associated with the data processing platform or the data processing platform component 404.

In some implementations, to obtain the context, a client application (e.g., the client 120 shown in FIG. 1), may obtain the context based on an evaluation of user interface code used to render the user interface 402. For example, obtaining the context based on the evaluation of the user interface code may include accessing a set of specified fields included in the user interface code or reading the specified fields included in the user interface code, among other examples. In some implementations, the client application may also obtain the context by querying an application programming interface (API) or other interface associated with the data processing platform component 404. In some implementations, a component other than the client application may obtain the context. For example, a service interface (e.g., the service interface 306 shown in FIG. 3) may obtain the context based on user interaction with the user interface element 406. In some implementations, the service interface may obtain, based on the user interaction with the user interface element 406, a set of parameters associated with the data processing platform component 404 that is used to generate the debug request 408. The set of parameters may include identifiers, component names, product names, version information, or other information associated with the data processing platform component 404.

The debug request 408 is received by a service interface 410, which may be, be similar to, include, or be included in the service interface 306 shown in FIG. 3. As indicated above, the debug request 408 may include a component ID corresponding to the component being debugged, as well as additional context information such as a product name or component name.

The service interface 410 processes the debug request 408 and generates request data 412. The request data 412 may include structured information derived from the debug request 408, formatted to facilitate efficient processing by subsequent components of the debugging system. In some implementations, the request data 412 may contain key-value pairs representing various attributes of the component being debugged, such as the component ID, product name, component type, and version information. The request data 412 may also include additional contextual information, such as timestamps, user identifiers, or session data, which may help in narrowing down the scope of the debugging process. In some cases, the request data 412 may be enriched with metadata from the service interface 410, which may include, for example, information about the current system state or recent activities related to the component in question. This structured format of the request data 412 may enable the query builder 414 to more effectively construct targeted search queries, potentially improving the relevance and efficiency of the subsequent error data retrieval process.

The request data 412 is passed to a query builder 414, which may be, be similar to, include, or be included in the query builder 310 shown in FIG. 3. The query builder 414 may be configured to construct an appropriate search query 416 based on the information provided in the debug request. In some implementations, the query builder 414 may employ ML techniques to optimize query generation. The query builder 414 may analyze historical debugging data and user feedback to improve its performance over time, potentially reducing the number of iterations required to locate relevant error data.

The query builder 414 may utilize any number of various techniques to generate the query 416. In some implementations, the query builder 414 may employ a template-based approach, where predefined query templates are populated with specific information from the request data 412. These templates may be designed to target common error patterns or specific component types. The query builder 414 may incorporate natural language processing techniques to analyze the context provided in the debug request, extracting key terms and concepts to formulate more precise queries. In some cases, the query builder 414 may use a hierarchical approach, starting with broad queries and progressively refining them based on initial results. The query builder 414 may also consider factors such as time ranges, log levels, and component relationships when constructing the query 416. Additionally, the query builder 414 may incorporate feedback mechanisms, providing a mechanism by which it may learn from successful queries and adjust its strategies based on the effectiveness of previous debugging sessions.

In some implementations, the query builder 414 may construct a query 416 that specifies a dataset identifier corresponding to internal platform logs, a log level filter set to an error level, and a component identifier extracted from the debug request. For example, the query 416 may be structured as a set of key-value pairs specifying a target dataset (e.g., internal logs of the data processing platform), a severity filter (e.g., error-level entries), and a component identifier to scope the results to the specific component being debugged. This targeted query structure may facilitate efficient retrieval of the most relevant error data by limiting the search to error-level entries in the internal log dataset that are associated with the identified component.

The query builder 414 passes the query 416 to a search client 418. The search client 418 may be, be similar to, include, or be included in the search client 308 shown in FIG. 3. The search client 418 may be configured to retrieve relevant error data associated with the component being debugged. For example, the search client 418 may be configured to interact with a search service 422, which may be, be similar to, include, or be included in the search platform 108 shown in FIG. 1. The search service 422 may be configured to execute the search query 420 to search a log store 424.

The log store 424 contains logs 426 related to the data processing platform and its components (e.g., the data processing platform component 404). In some implementations, the log store 424 may be distributed across multiple storage systems or geographical locations. The search service 422 retrieves error data 428 from the log store 424 based on the search query 420.

The search service 422 may query the log store 424 using any number of various techniques to efficiently retrieve relevant error data 428. In some implementations, the search service 422 may utilize distributed search algorithms to parallelize the query execution across multiple nodes of the log store 424. The search service 422 may employ indexing strategies, such as inverted indices or time-series indices, to optimize query execution based on the structure of the logs 426. In some cases, the search service 422 may implement caching mechanisms to store frequently accessed log data or query results, thereby reducing response times for subsequent similar queries. The search service 422 may also support advanced query features, such as full-text search, regular expression matching, or aggregations, to enable complex log analysis operations. In some implementations, the search service 422 may apply access control policies to facilitate returning only authorized data in response to the search query 420, maintaining data security and privacy within the debugging process.

The error data 428 is then passed back through the search client 418 to the service interface 410 as error data 430. In some implementations, the error data 430 may include information such as error messages, stack traces, or relevant log entries associated with the component being debugged.

In some implementations, the search client 418 or the service interface 410 may extract specific fields from the log entries returned by the search service 422 before passing the error data 430 to the prompt builder 434. For example, each log entry returned from the log store 424 may include multiple fields such as a timestamp, a source identifier, a severity level, and an error message string. The search client 418 or the service interface 410 may extract only the error message strings from the returned log entries, discarding the remaining fields. By passing only the extracted error message strings to the prompt builder 434 rather than the full log entries, the system may reduce the volume of data included in the prompt 436, thereby reducing token consumption by the ML component 438 and focusing the ML component 438 on the most diagnostically relevant information.

In some implementations, the error data 428 retrieved from the log store 424 may include a limited set of error messages. For example, the search service 422 may return a set of error messages numbering in the single digits (e.g., between approximately five and ten error messages). Limiting the number of error messages included in the error data 428 may improve the relevance and focus of the subsequently generated prompt 436, reduce token consumption by the ML component 438, and facilitate more targeted analysis by the ML component 438. In some implementations, the search service 422 or the search client 418 may apply result-count limits, recency filters, or relevance ranking to produce the limited set of error messages from a potentially larger volume of log data.

The service interface 410 passes the error data 430 to a prompt builder 434, which may be, be similar to, include, or be included in the prompt builder 312 shown in FIG. 3. The prompt builder 434 uses this error data to generate a prompt 436 for an ML component 438. In some implementations, the prompt builder 434 may utilize natural language processing techniques to transform the error data and contextual information into a well-formed prompt. The prompt builder 434 generates a prompt 436 that incorporates the error data 430 and any additional context or metadata related to the component being debugged.

The prompt builder 434 may employ any number of various techniques to generate an effective prompt 436 for the ML component 438. In some implementations, the prompt builder 434 may utilize a library of pre-defined prompt templates designed for different types of debugging scenarios. These templates may include placeholders for specific error data, component information, and contextual details. The prompt builder 434 may select an appropriate template based on factors such as the error type, component characteristics, and debugging context, then populate the template with the relevant information gathered from the error data 430 and additional metadata.

In some implementations, the prompt 436 generated by the prompt builder 434 may include structured sections such as a context section and a query section. For example, the prompt 436 may include a context section that identifies the component by its product name, component name, and component ID, followed by the error messages retrieved from the log store 424. The prompt 436 may conclude with a query section requesting that the ML component 438 analyze the provided error data and generate instructions for resolving the identified issue. For example, the prompt 436 may include text such as: "An issue has been identified with [product name], specifically with [component name] (ID: [component ID]). The following error messages were retrieved from the internal logs: [error message 1]; [error message 2]; [error message N]. Based on these errors, provide step-by-step instructions to diagnose and resolve the issue."

In some cases, the prompt builder 434 may incorporate a database of successful prompt examples from previous debugging sessions. By analyzing these examples, the prompt builder 434 may identify patterns and structures that have proven effective in eliciting useful responses from the ML component 438. The prompt builder 434 may then adapt these successful patterns to the current debugging context, thereby improving the quality and relevance of the generated prompt 436. This approach may allow the prompt builder 434 to continuously refine its prompt generation strategies based on real-world debugging experiences.

The prompt builder 434 may leverage ML techniques to enhance its prompt generation capabilities. In some implementations, the prompt builder 434 may utilize natural language processing models to analyze the error data 430 and extract key information, such that the most relevant details may be prominently featured in the prompt 436. In some implementations, the prompt builder 434 may employ generative models trained on historical debugging data to create custom prompts tailored to specific debugging scenarios. These ML-based approaches may enable the prompt builder 434 to generate more nuanced and context-aware prompts, thereby improving the overall effectiveness of the debugging process.

The prompt 436 is then passed to the ML component 438, which may include one or more LLMs 440. As used herein, "LLM" may refer to one LLM or more than one LLM. In some implementations, the ML component 438 may be, be similar to, include, or be included in the ML component 118 shown in FIG. 1. The LLM 440 processes the prompt 436 to generate insights and potential solutions for the debugging issue.

In some implementations, the ML component 438 may operate in a stateless, prompt-driven mode in which the ML component 438 receives only the prompt 436 as input and does not independently access additional data sources or external systems during processing. In such implementations, the prompt 436 generated by the prompt builder 434 represents the complete context available to the ML component 438 for generating the debug output 442. This prompt-driven approach may simplify the integration of the ML component 438 with the debug service 302 and may reduce the computational overhead associated with the debugging process by constraining the scope of information the ML component 438 processes. In other implementations, the ML component 438 may have access to additional data sources, as described elsewhere herein.

The LLM 440 may process the prompt 436 using advanced natural language understanding and generation techniques. In some implementations, the LLM 440 may first tokenize the input prompt, breaking it down into individual words, subwords, or characters that may be processed by a neural network. The tokenized input may then be encoded into a high-dimensional vector representation, capturing the semantic meaning and contextual relationships within the prompt. This encoded representation may be processed through multiple layers of the neural network, providing a mechanism by which the model may analyze the prompt at various levels of abstraction and complexity.

During processing, the LLM 440 may leverage pre-trained knowledge of programming concepts, error patterns, and debugging techniques to interpret the context provided in the prompt. The model may identify key elements such as error types, component relationships, and system states, correlating this information with their vast knowledge base to generate relevant insights. In some cases, the LLM 440 may employ attention mechanisms to focus on the most pertinent parts of the input, facilitating more precise and targeted analysis of the debugging scenario.

The output generation process may involve the LLM 440 iteratively producing tokens that form coherent natural language responses. These responses may include explanations of potential root causes, step-by-step debugging instructions, or suggestions for code modifications to resolve the identified issues. In some implementations, the LLM 440 may generate multiple candidate responses and employ beam search or other decoding strategies to select the most appropriate and relevant output. The generated debug output may be further refined through post-processing steps, such as filtering for relevance, formatting for readability, or applying domain-specific constraints to facilitate aligning the output with the debugging context and user expectations.

In some implementations, the LLM 440 may employ agentic AI techniques to process the prompt 436 and generate more comprehensive debugging solutions. This approach may involve the LLM 440 acting as autonomous agents capable of breaking down complex debugging tasks into smaller, manageable subtasks. The agentic AI may dynamically formulate and execute a series of intermediate queries or analyses, potentially interacting with other components of the debugging system to gather additional information as needed. For example, the LLM 440 may generate follow-up questions to clarify ambiguous aspects of the error, request specific log entries from the search service 422, or simulate potential fixes to validate their effectiveness. This iterative and interactive process may allow the LLM 440 to explore multiple debugging paths simultaneously, adapting their strategy based on intermediate results and newly acquired information. By leveraging agentic AI capabilities, the LLM 440 may provide more thorough, context-aware, and actionable debugging outputs, thereby improving the overall efficiency and effectiveness of the automated debugging process.

The ML component 438 produces a debug output 442, which may include natural language textual instructions for resolving the identified issue. In some implementations, the debug output 442 may include machine-readable instructions that may be used to facilitate the orchestration of error mitigation.

The debug output 442 is provided to the service interface 410, which may convert the debug output 442 into a debug output representation 444, which is suitable for display in the user interface 402. The debug output representation 444 is sent back through the service interface 410 to the user interface 402, where it is presented to the user in a debug user interface 446. In some implementations, the debug user interface 446 may display the debug output as step-by-step instructions for resolving the issue associated with the component. These instructions may be presented in a single text field, providing a guide for the user to follow.

Building upon the debugging process described above, the system may also incorporate automated mitigation capabilities to address identified issues. FIG. 4B illustrates an extension of the data flow that focuses on error resolution and mitigation. This mitigation workflow may be initiated based on user interaction with the debug output or through automated processes triggered by certain debug results. The mitigation process may leverage the insights generated by the ML component to formulate and execute corrective actions, potentially reducing the time and effort required to resolve issues within the data processing platform.

FIG. 4B illustrates a data flow 448 for processing a mitigation request based on the debug output. The user interface 402 in FIG. 4B includes a user interface element 450 displayed within the debug user interface 446, which may be used to initiate a mitigation request. In some implementations, the user interface element 450 may be a button or link labeled "Fix" or "Apply Solution," providing a mechanism by which the user may trigger the automated mitigation process.

When a user interacts with the user interface element 450, a mitigation request 452 is generated and sent to the data processing platform component 404. The mitigation request 452 is received by the service interface 410, which processes the request and initiates the mitigation workflow. In some implementations, the mitigation workflow may be autonomously initiated based on the debug output 442.

The service interface 410 may generate prompt data 454 based on the mitigation request and any additional context from the previous debugging session. This prompt data 454 is passed to the prompt builder 434, which creates a prompt 456 designed to elicit mitigation instructions from the ML component.

The prompt 456 is sent to the ML component 438, which processes it using the LLM 440. In this case, the LLM 440 may be tasked with generating specific, actionable steps for resolving the identified issue.

The ML component 438 produces a mitigation output 458, which may include machine-readable instructions for implementing the fix. The mitigation output 458 is passed to a mitigation component 460, which may be configured to execute the machine-readable instructions to facilitate an orchestration to autonomously perform one or more mitigation operations indicated by the debug output.

As used herein, the term "orchestration" may refer to the automated coordination and management of multiple processes, services, or components within a system. In the context of data processing platforms and debugging workflows, orchestration may involve the systematic arrangement and execution of various tasks, such as error detection, analysis, mitigation planning, and implementation of corrective actions. Corrective actions may include, for example, generating or editing computer code associated with the data processing platform component. Orchestration may encompass the sequencing of operations, management of dependencies between different system components, and the allocation of resources to facilitate efficient and effective resolution of identified issues.

Facilitating an orchestration to perform one or more mitigation operations indicated by the debug output may involve the coordination of multiple system components to execute a series of actions aimed at resolving the identified issue. This process may include interpreting the machine-readable instructions generated by the ML component, translating these instructions into specific system commands or API calls, and sequentially executing these commands across relevant parts of the data processing platform. The orchestration may manage the timing and order of these operations, such that prerequisites may be met before subsequent steps are initiated, and handling any interdependencies between different components of the system.

In some implementations, facilitating the orchestration may also involve monitoring the progress of mitigation operations, handling any errors or unexpected conditions that arise during the process, and potentially rolling back changes if a mitigation attempt is unsuccessful. The orchestration may adapt to the specific context of the debugging scenario, potentially leveraging system metadata, configuration information, and real-time feedback to optimize the execution of mitigation operations. By automating this process, the system may reduce the need for manual intervention, thereby increasing the speed and reliability of error resolution within the data processing platform.

In some implementations, the mitigation component 460 may interface with various parts of the data processing platform to apply the suggested changes. This may involve updating configuration files, restarting services, or modifying data processing pipelines as necessary to resolve the identified issue.

In some implementations, the machine-readable instructions generated by the ML component 438 may be structured in a defined format that the mitigation component 460 may parse and execute. For example, the machine-readable instructions may be formatted as a structured data object (e.g., a JavaScript Object Notation (JSON) object) that includes an ordered list of mitigation actions. Each mitigation action in the list may include an action type field (e.g., "restart_component," "update_configuration," "modify_pipeline," or "execute_command"), a target field identifying the component or resource to which the action applies (e.g., a component ID or resource path), and a parameters field containing key-value pairs specific to the action type (e.g., a configuration key and its new value, or a command string to execute).

The mitigation component 460 may include a parser that validates the structure of the machine-readable instructions against a predefined schema before execution. The parser may verify that each action type is a recognized action from a set of permitted action types, that each target corresponds to a valid component or resource within the data processing platform, and that the parameters conform to expected types and value ranges. If the machine-readable instructions do not conform to the schema or include unrecognized action types, the mitigation component 460 may reject the instructions and return an error to the service interface 410.

Upon successful validation, the mitigation component 460 may execute the mitigation actions sequentially. For each action, the mitigation component 460 may invoke a corresponding handler function that translates the action into one or more platform-specific operations. For example, a "restart_component" action may cause the mitigation component 460 to issue a restart command to the identified component via an application programming interface (API) of the data processing platform. An "update_configuration" action may cause the mitigation component 460 to modify a configuration file or update a configuration value in a configuration store associated with the target component. The mitigation component 460 may record the state of the system before each action to support rollback in the event that a subsequent action fails.

In some implementations, the mitigation component 460 may operate within a sandboxed execution environment that restricts the scope of actions the mitigation component 460 may perform. For example, the sandboxed environment may limit the mitigation component 460 to a predefined set of action types and may restrict write access to a defined set of configuration parameters or resources. This sandboxed approach may reduce the risk of unintended changes to the data processing platform resulting from the execution of machine-readable instructions generated by the ML component 438.

The data flows 400 and 448 illustrate the approach to automated debugging and error resolution provided by this disclosure. By integrating user interface interactions, intelligent search capabilities, ML analysis, and automated mitigation, the system may diagnose and resolve issues in complex data processing environments. This approach may improve system reliability and reduce downtime for organizations utilizing data processing platforms.

In some implementations, the system may support iterative debugging sessions, providing a mechanism by which users may refine their queries or provide additional context based on initial results. This may involve multiple rounds of communication between the user interface 402 and the data processing platform component 404, with each iteration potentially involving different components as needed to further clarify or resolve the issue.

The integration of the LLM 440 within the ML component 438 facilitates analysis of error patterns and generation of context-aware solutions. This capability provides a mechanism by which the system may provide debugging advice, potentially adapting to new types of errors or evolving system architectures over time.

In this configuration, the data flows 400 and 448 orchestrate the automated debugging and mitigation processes for data processing platforms, aiming to resolve issues and reduce system downtime. The integration of user interface elements, search capabilities, ML analysis, and automated mitigation facilitates debugging that may be performed by users with varying levels of technical expertise, potentially enhancing the reliability and maintainability of data processing environments.

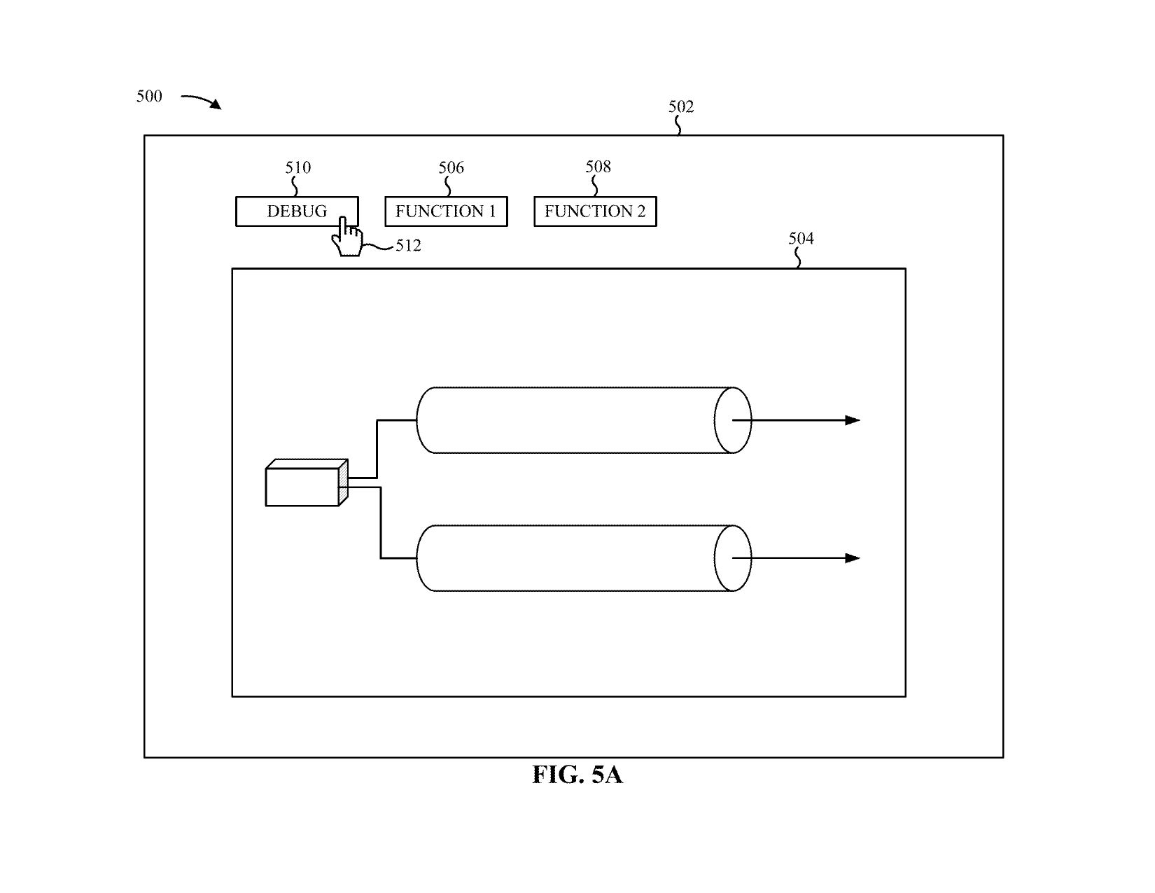

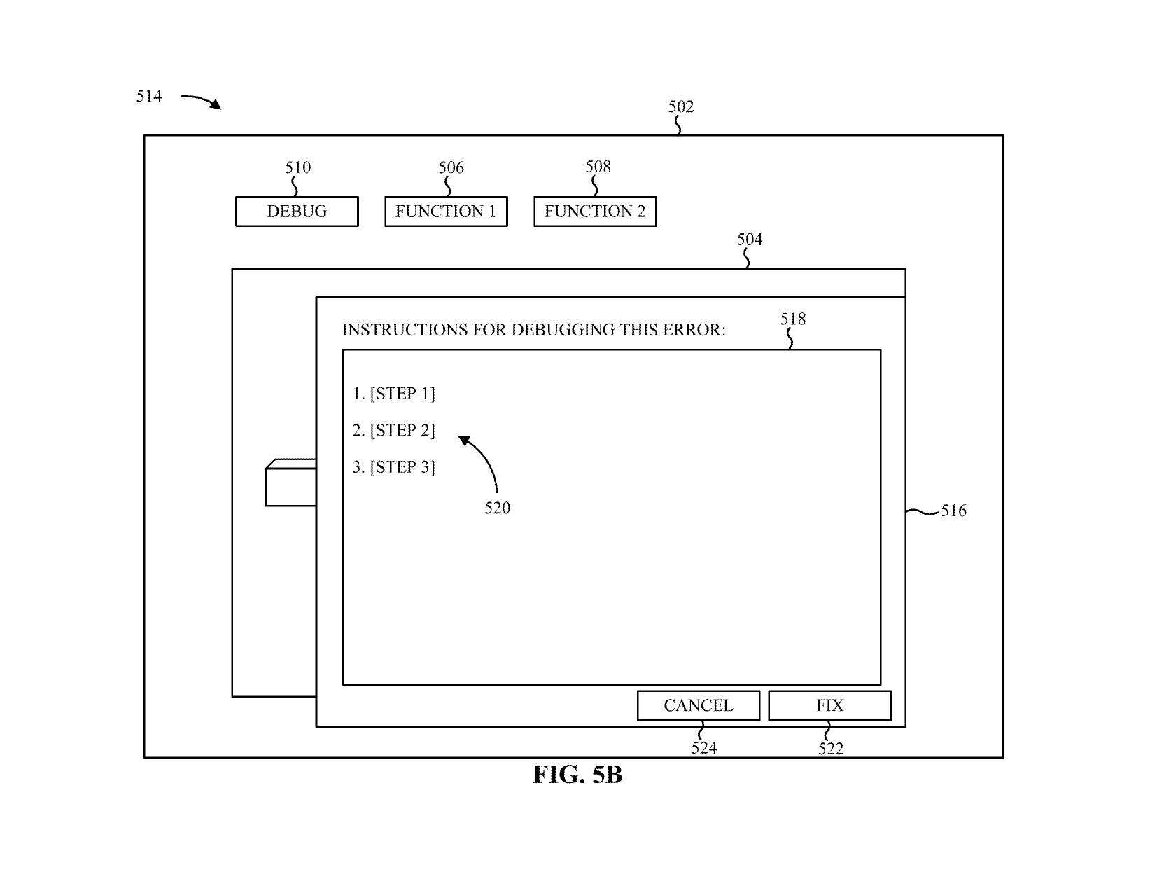

FIGS. 5A and 5B are diagrams of example user interfaces associated with automated debugging for data processing platforms. FIG. 5A illustrates an example 500 of a user interface 502 containing a workspace 504. The user interface 502 may correspond to a data processing platform component (e.g., the data processing platform component 404 shown in FIG. 4A). For example, the user interface 502 may be, be similar to, include, or be included in the user interface 402 shown in FIG. 4A.

The user interface 502 includes a first function element 506 labeled "FUNCTION 1" and a second function element 508 labeled "FUNCTION 2". The function elements 506 and 508 may be user interface controls associated with one or more functions or capabilities of the data processing platform component. The function elements 506 and 508 may be interactive elements. For example, the function element 506 may be activated when a user places a cursor over the function element 506, clicks the function element 506, or otherwise provides a selection of the function element 506. The function element 508 may be activated in a similar manner. The workspace 504 may represent a visual representation of a data processing pipeline or a portion thereof. The function elements 506 and 508 may correspond to individual processing steps or operations within the pipeline.

A debug user interface element 510 labeled "DEBUG" is positioned adjacent to the function elements. A cursor 512 is shown positioned near the debug user interface element 510. The debug user interface element 510 may be contextually associated with the data processing platform component associated with the user interface 502. In some implementations, for example, the debug user interface element 510 may be contextually associated with a data processing pipeline represented in the workspace 504. In some implementations, the debug user interface element 510 may be a button, link, or other interactive element that provides a mechanism by which a user may initiate a debug request. The positioning of the debug user interface element 510 adjacent to the function elements may provide users with an intuitive way to access debugging functionality for specific parts of the data processing pipeline.

The cursor 512 shown near the debug user interface element 510 may represent a user's interaction with the user interface 502. In some implementations, when a user moves the cursor 512 over the debug user interface element 510 and clicks or otherwise activates it, a debug request may be generated and sent to a debug service, such as the debug service 116 shown in FIG. 1 or the debug service 302 shown in FIG. 3.

FIG. 5B illustrates an example 514 of the user interface 502 after a debug request has been initiated and processed. FIG. 5B shows a debug user interface 516 that has been displayed in response to the debug request. The debug user interface 516 may be designed to present the results of the automated debugging process in a user-friendly manner. In some implementations, the debug user interface 516 may appear as an overlay or a separate panel within the user interface 502. The debug user interface 516 includes a single text field 518 that displays step-by-step instructions 520 for resolving the identified issue.

The step-by-step instructions 520 may be generated based on the output of an ML component, such as the ML component 118 shown in FIG. 1 or the ML component 438 shown in FIGS. 4A and 4B. In some implementations, these instructions may be presented as natural language text, making them easily understandable to users with varying levels of technical expertise. The instructions may provide a clear, sequential guide for addressing the issue associated with the component being debugged.

At the bottom of the debug user interface 516, there are two control elements: a mitigation user interface element 522 labeled "FIX" and a cancel user interface element 524 labeled "CANCEL". These elements allow users to either proceed with implementing the suggested fixes or cancel the debugging operation. The mitigation user interface element 522 may be used to initiate an automated mitigation process such as, for example, the process associated with the data flow 448 shown in FIG. 4B. This may trigger the execution of machine-readable instructions to autonomously apply the suggested fixes to the data processing pipeline.

The cancel user interface element 524 provides users with the option to exit the debugging process without applying any changes. In some implementations, interacting with the cancel user interface element 524 may close the debug user interface 516 and return the user interface 502 to its previous state.

The layout and design of the debug user interface 516 may be optimized for clarity and ease of use. In some implementations, the text field 518 may be scrollable to accommodate longer sets of instructions. The step-by-step instructions 520 may be formatted with numbered or bulleted lists to enhance readability and guide users through the resolution process.

In some implementations, the debug user interface 516 may include additional features not shown in FIG. 5B. For example, the debug user interface 516 may incorporate expandable sections that provide more detailed information about specific steps or technical explanations. The debug user interface 516 may include links to relevant documentation or support resources.

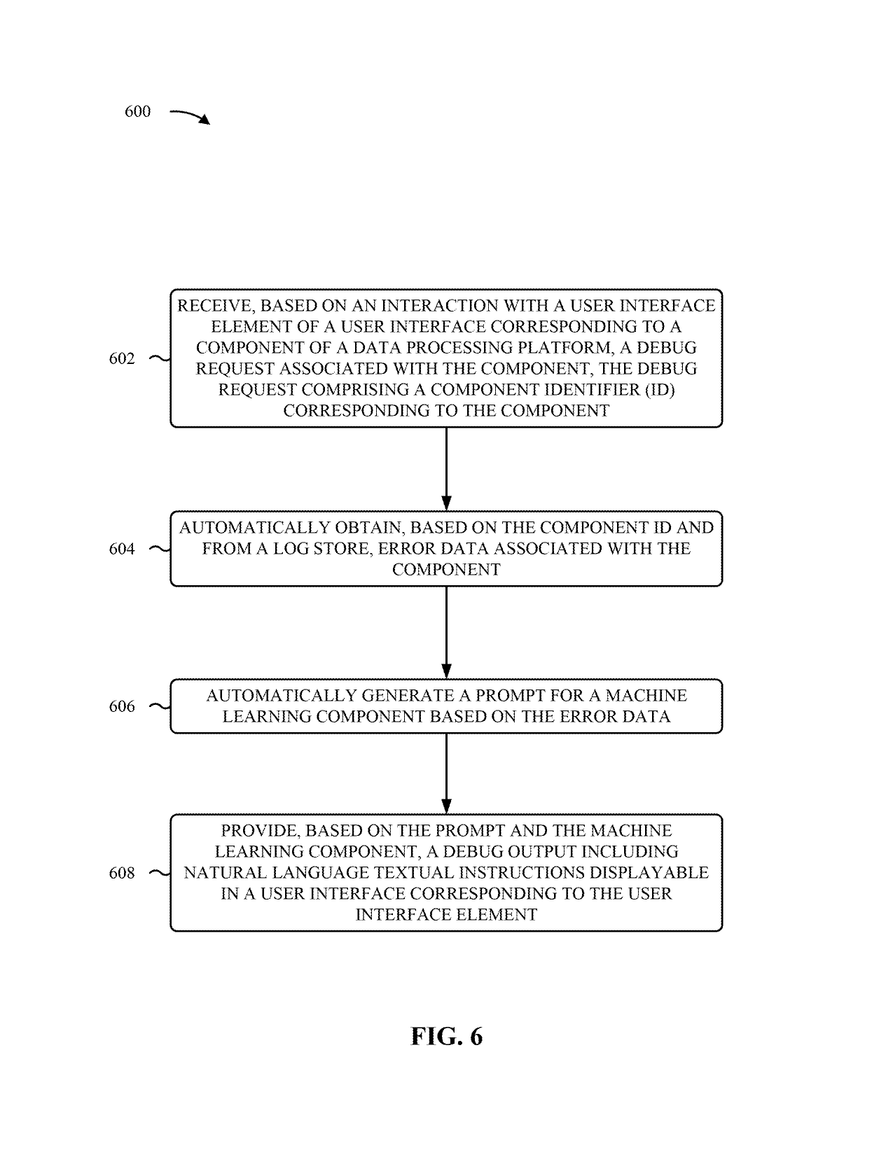

To further describe some implementations in greater detail, reference is next made to examples of techniques which may be performed by or using a system as described herein. FIG. 6 is a flowchart of an example of a technique 600 associated with automated debugging for data processing platforms. The technique 600 may be executed using computing devices, such as the systems, hardware, and software described with respect to FIGS. 1-5B. The technique 600 may be performed, for example, by executing a machine-readable program or other computer-executable instructions, such as routines, instructions, programs, or other code. The steps, or operations, of the technique 600, or another technique, method, process, or algorithm described in connection with the implementations disclosed herein may be implemented directly in hardware, firmware, software executed by hardware, circuitry, or a combination thereof.

For simplicity of explanation, the technique 600 is depicted and described herein as a series of steps or operations. However, the steps or operations of the technique 600 may occur in various orders and/or concurrently. Additionally, other steps or operations not presented and described herein may be used. Furthermore, not all illustrated steps or operations may be required to implement a technique in accordance with the disclosed subject matter.

At 602, the technique 600 may include receiving, based on an interaction with a user interface element of a user interface corresponding to a component of a data processing platform, a debug request associated with the component. In some implementations, the debug request may comprise a component ID corresponding to the component. The user interface element may be contextually associated with the component of the data processing platform. For example, the user interface element may be a button, link, or other interactive element positioned near a visual representation of the component within the user interface. The component of the data processing platform may include a data pipeline (or a portion thereof) or a search interface (or a portion thereof), among other examples.

In some implementations, the technique 600 may further include obtaining, based on the interaction, a context corresponding to the component. The context may comprise the component ID and at least one of a component name or a product name of a product corresponding to the component. In some aspects, obtaining the context may comprise obtaining the context based on an evaluation of user interface code used to render the user interface corresponding to the component. This may involve accessing a set of specified fields of the user interface code to extract relevant information about the component and its environment.

At 604, the technique 600 may include obtaining, based on the component ID and from a log store, error data associated with the component. In some implementations, obtaining the error data may comprise generating a query corresponding to the log store, providing the query to a search service configured to query the log store, and retrieving, based on the query and via the search service, the error data from the log store. The search service may be designed to efficiently retrieve and process large volumes of log data from various sources within the data processing platform.

At 606, the technique 600 may include generating a prompt for an ML component based on the error data. In some implementations, the ML component may include an LLM. In some implementations, the ML component may include more than one LLM, one or more ML agents, or other ML models configured to perform classification of errors, analysis of error data, or iterative inferences or generations, among other examples. The prompt may be designed to elicit relevant and actionable responses from the system involved in the debugging process. In some aspects, prior to generating the prompt, the technique 600 may include identifying an error message displayed in the user interface and including the error message in the prompt. This may provide additional context to the ML component for more accurate analysis.

At 608, the technique 600 may include providing, based on the prompt and the ML component, a debug output including natural language textual instructions displayable in a user interface corresponding to the user interface element. In implementations where the ML component includes an LLM, the technique 600 may further include inferring the debug output by processing the prompt with the LLM. The debug output may comprise step-by-step instructions for resolving an issue associated with the component.

In some implementations, the user interface corresponding to the user interface element may include a single text field that includes the step-by-step instructions. This presentation format may provide users with a clear and concise guide for addressing the identified issue. The debug output may be designed to be easily understandable by users with varying levels of technical expertise, thereby enhancing the usability of the debugging system.

In some aspects, the technique 600 may further include receiving machine readable instructions from the ML component and facilitating, based on executing the machine readable instructions, an orchestration to autonomously perform one or more mitigation operations indicated by the debug output. This automated mitigation capability may help reduce the time and effort required to resolve issues within the data processing platform.

The user interface corresponding to the user interface element may be referred to as a debug user interface. The debug user interface may include an additional user interface element. In some implementations, the technique 600 may include receiving, based on an interaction with the additional user interface element, a mitigation request. Executing the machine readable instructions may comprise executing the machine readable instructions based on the mitigation request. This may provide users with the option to review and approve suggested fixes before they are applied to the system.

In some implementations, the technique 600 may be extended to support debugging across multiple components or data processing pipelines. For example, the technique 600 may include receiving, based on an interaction with an additional user interface element of an additional user interface corresponding to an additional component of the data processing pipeline or an additional data processing pipeline, an additional debug request associated with the additional component. The additional debug request may comprise an additional component ID corresponding to the additional component.

The technique 600 may then include obtaining, based on the additional component ID and from at least one of the log store or an additional log store, additional error data associated with the additional component. An additional prompt may be autonomously generated for the LLM based on the additional error data and additional metadata corresponding to the additional component. The technique 600 may then include inferring, by processing the additional prompt with the LLM, an additional debug output including additional natural language textual instructions displayable in an additional user interface corresponding to the additional user interface element.

This extensibility may allow the debugging system to handle complex scenarios involving multiple interconnected components or data processing pipelines, providing a comprehensive solution for maintaining and troubleshooting large-scale data processing environments. By leveraging the power of ML and natural language processing, the technique 600 may streamline the debugging process, thereby reducing system downtime and improving overall reliability of data processing platforms.

Some implementations include a method, comprising: receiving, based on an interaction with a user interface element of a user interface corresponding to a component of a data processing platform, a debug request associated with the component, the debug request comprising a component identifier (ID) corresponding to the component; obtaining, from a log store and based on the component ID, error data associated with the component; generating a prompt for a large language model based on the error data and metadata corresponding to the component; and providing, by processing the prompt with the large language model, a debug output including natural language textual instructions displayable in a user interface corresponding to the user interface element.

In some implementations, the method further comprises obtaining, based on the interaction, a context corresponding to the component, the context comprising the component ID and at least one of a component name or a product name of a product corresponding to the data processing platform.

In some implementations, obtaining the context comprises obtaining the context based on an evaluation of user interface code used to render the user interface corresponding to the component.

In some implementations, obtaining the context comprises accessing a set of specified fields of the user interface code.

In some implementations, obtaining the error data comprises: generating a query corresponding to the log store; and retrieving, based on the query, the error data from the log store.

In some implementations, the method further comprises: generating, based on the debug output and by processing a mitigation prompt with the large language model, machine readable instructions that, when executed by a processing system, cause the processing system to facilitate an orchestration to perform one or more mitigation operations indicated by the debug output.

In some implementations, the user interface corresponding to the user interface element includes an additional user interface element, the method further comprising: receiving, based on an interaction with the additional user interface element, a mitigation request, wherein generating the machine readable instructions comprises generating the machine readable instructions based on the mitigation request.

In some implementations, the debug output comprises step-by-step instructions for resolving an issue associated with the component.

In some implementations, the user interface corresponding to the user interface element comprises a single text field that includes the step-by-step instructions.

In some implementations, the user interface element is contextually associated with the component.

In some implementations, the debug request further comprises a product name associated with the data processing platform and a component name associated with the component.

In some implementations, the method further comprises, prior to generating the prompt, identifying an error message displayed in the user interface and including the error message in the prompt.

In some implementations, the method further comprises: receiving, based on an interaction with an additional user interface element of an additional user interface corresponding to an additional component of the data processing platform, an additional debug request associated with the additional component, the additional debug request comprising an additional component ID corresponding to the additional component; obtaining, based on the additional component ID and from at least one of the log store or an additional log store, additional error data associated with the additional component; generating an additional prompt for the large language model based on the additional error data and additional metadata corresponding to the additional component of the data processing platform; and inferring, by processing the additional prompt with the large language model, an additional debug output including additional natural language textual instructions displayable in an additional user interface corresponding to the additional user interface element.

In some implementations, the method further comprises: receiving, based on an interaction with an additional user interface element of an additional user interface corresponding to an additional component of an additional data processing platform, an additional debug request associated with the additional component, the additional debug request comprising an additional component ID corresponding to the additional component; obtaining, based on the additional component ID and from at least one of the log store or an additional log store, additional error data associated with the additional component; generating an additional prompt for the large language model based on the additional error data and additional metadata corresponding to the additional component; and inferring, by processing the additional prompt with the large language model, an additional debug output including additional natural language textual instructions displayable in an additional user interface corresponding to the additional user interface element.

Some implementations include one or more non-transitory computer readable media storing instructions that, when executed by one or more processors, cause the one or more processors to perform operations, the operations comprising: receiving, based on an interaction with a user interface element of a user interface corresponding to a component of a data processing platform, a debug request associated with the component, the debug request comprising a component identifier (ID) corresponding to the component; obtaining, from a log store and based on the component ID, error data associated with the component; generating a prompt for a large language model based on the error data and metadata corresponding to the component; and providing, by processing the prompt with the large language model, a debug output including natural language textual instructions displayable in a user interface corresponding to the user interface element.

In some implementations, the operations further comprise obtaining, based on the interaction, a context corresponding to the component, the context comprising the component ID and at least one of a component name or a product name of a product corresponding to the component.

In some implementations, obtaining the context comprises obtaining the context based on an evaluation of user interface code used to render the user interface corresponding to the component.

Some implementations include a system, comprising: one or more memories; and one or more processors configured to execute instructions stored in the one or more memories to cause the system to: receive, based on an interaction with a user interface element of a user interface corresponding to a component of a data processing platform, a debug request associated with the component, the debug request comprising a component identifier (ID) corresponding to the component; obtain, from a log store and based on the component ID, error data associated with the component; generate a prompt for a large language model based on the error data and metadata corresponding to the component; and provide, by processing the prompt with the large language model, a debug output including natural language textual instructions displayable in a user interface corresponding to the user interface element.

In some implementations, to obtain the error data, the one or more processors are configured to execute the instructions to cause the system to: generate a query corresponding to the log store; provide the query to a search service configured to query the log store; and retrieve, based on the query and via the search service, the error data from the log store.

In some implementations, the one or more processors are configured to execute the instructions to cause the system to: receive machine readable instructions from the large language model; and facilitate, based on executing the machine readable instructions, an orchestration to perform one or more mitigation operations indicated by the debug output.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to "at least one of" a list of items refers to any combination of those items, including single members. As an example, "at least one of: a, b, or c" is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles "a" and "an" are intended to include one or more items and may be used interchangeably with "one or more." Further, as used herein, the article "the" is intended to include one or more items referenced in connection with the article "the" and may be used interchangeably with "the one or more." Furthermore, as used herein, the terms "set" and "group" are intended to include one or more items (e.g., related items, unrelated items, or a combination of related and unrelated items), and may be used interchangeably with "one or more." Where only one item is intended, the phrase "only one" or similar language is used. Also, as used herein, the terms "has," "have," "having," or the like are intended to be open-ended terms. Further, the phrase "based on" is intended to mean "based, at least in part, on" unless explicitly stated otherwise. Also, as used herein, the term "or" is intended to be inclusive when used in a series and may be used interchangeably with "and/or," unless explicitly stated otherwise (e.g., if used in combination with "either" or "only one of").

The adjectives "first," "second," "third," and so on are used for contextual distinction between two or more of the modified nouns in connection with a discussion and are not meant to be absolute modifiers that apply only to a certain respective node throughout the entire document. For example, a component may be referred to as a "first component" in connection with one discussion and may be referred to as a "second component" in connection with another discussion, or vice versa. Reference to a component, a computing device, a server, a client, an application, an apparatus, a device, a system, a computing system, or the like may include disclosure of the computing device, server, client, application, apparatus, device, system, computing system, or the like, respectively, being a node. For example, disclosure that a computing device is configured to receive information from a server also discloses that a first node is configured to receive information from a second node. Consistent with this disclosure, once a specific example is broadened in accordance with this disclosure (e.g., a computing device is configured to receive information from a server also discloses that a first node is configured to receive information from a second node), the broader example of the narrower example may be interpreted in the reverse, but in a broad open-ended way. In the example above where a computing device being configured to receive information from a server also discloses a first node being configured to receive information from a second node, "first node" may refer to a first computing device, a first server, a first client, a first application, a first apparatus, a first device, a first system, a first computing system, or the like, configured to receive the information from a second node; and "second node" may refer to a second computing device, a second server, a second client, a second application, a second apparatus, a second device, a second system, a second computing system, or the like.

As used herein, unless explicitly stated otherwise, any term specified in the singular may include its plural version. For example, "a computer that stores data and runs software," may include a single computer that stores data and runs software or two computers a first computer that stores data and a second computer that runs software. Also "a computer that stores data and runs software," may include multiple computers that together stored data and run software. At least one of the multiple computers stores data, and at least one of the multiple computers runs software.

As used herein, the term "computer-readable medium" encompasses one or more computer readable media. A computer-readable medium may include any storage unit (or multiple storage units) that store data or instructions that are readable by a processing system. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

The implementations of this disclosure may be described in terms of functional block components and various processing operations. Such functional block components may be realized by a number of hardware or software components that perform the specified functions. For example, the disclosed implementations may employ various integrated circuit components (e.g., memory elements, processing elements, logic elements, look-up tables, and the like), which may carry out a variety of functions under the control of one or more microprocessors or other control devices. Similarly, where the elements of the disclosed implementations are implemented using software programming or software elements, the systems and techniques may be implemented with a programming or scripting language, such as C, C++, Java, JavaScript, assembler, or the like, with the various algorithms being implemented with a combination of data structures, objects, processes, routines, or other programming elements.

Functional aspects may be implemented in algorithms that execute on one or more processors. Furthermore, the implementations of the systems and techniques disclosed herein may employ a number of conventional techniques for electronics configuration, signal processing or control, data processing, and the like. The words "mechanism" and "component" are used broadly and are not limited to mechanical or physical implementations, but may include software routines in conjunction with processors, etc. Likewise, the terms "system" or "tool" as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, based on an interaction with a user interface element of a user interface corresponding to a component of a data processing platform, a debug request associated with the component, the debug request comprising a component identifier (ID) corresponding to the component;
obtaining, from a log store and based on the component ID, error data associated with the component;
generating a prompt for a large language model based on the error data and metadata corresponding to the component; and
providing, by processing the prompt with the large language model, a debug output including natural language textual instructions displayable in a user interface corresponding to the user interface element.

2. The method of claim 1, further comprising obtaining, based on the interaction, a context corresponding to the component, the context comprising the component ID and at least one of a component name or a product name of a product corresponding to the data processing platform.

3. The method of claim 2, wherein obtaining the context comprises obtaining the context based on an evaluation of user interface code used to render the user interface corresponding to the component.

4. The method of claim 3, wherein obtaining the context comprises accessing a set of specified fields of the user interface code.

5. The method of claim 1, wherein obtaining the error data comprises:
generating a query corresponding to the log store; and
retrieving, based on the query, the error data from the log store.

6. The method of claim 1, further comprising:
generating, based on the debug output and by processing a mitigation prompt with the large language model, machine readable instructions that, when executed by a processing system, cause the processing system to facilitate an orchestration to perform one or more mitigation operations indicated by the debug output.

7. The method of claim 6, wherein the user interface corresponding to the user interface element includes an additional user interface element, the method further comprising:
receiving, based on an interaction with the additional user interface element, a mitigation request, wherein generating the machine readable instructions comprises generating the machine readable instructions based on the mitigation request.

8. The method of claim 1, wherein the debug output comprises step-by-step instructions for resolving an issue associated with the component.

9. The method of claim 8, wherein the user interface corresponding to the user interface element comprises a single text field that includes the step-by-step instructions.

10. The method of claim 9, wherein the user interface element is contextually associated with the component.

11. The method of claim 1, wherein the debug request further comprises a product name associated with the data processing platform and a component name associated with the component.

12. The method of claim 1, further comprising, prior to generating the prompt, identifying an error message displayed in the user interface and including the error message in the prompt.

13. The method of claim 1, further comprising:
receiving, based on an interaction with an additional user interface element of an additional user interface corresponding to an additional component of the data processing platform, an additional debug request associated with the additional component, the additional debug request comprising an additional component ID corresponding to the additional component;
obtaining, based on the additional component ID and from at least one of the log store or an additional log store, additional error data associated with the additional component;
generating an additional prompt for the large language model based on the additional error data and additional metadata corresponding to the additional component of the data processing platform; and
inferring, by processing the additional prompt with the large language model, an additional debug output including additional natural language textual instructions displayable in an additional user interface corresponding to the additional user interface element.

14. The method of claim 1, further comprising:
receiving, based on an interaction with an additional user interface element of an additional user interface corresponding to an additional component of an additional data processing platform, an additional debug request associated with the additional component, the additional debug request comprising an additional component ID corresponding to the additional component;
obtaining, based on the additional component ID and from at least one of the log store or an additional log store, additional error data associated with the additional component;
generating an additional prompt for the large language model based on the additional error data and additional metadata corresponding to the additional component; and
inferring, by processing the additional prompt with the large language model, an additional debug output including additional natural language textual instructions displayable in an additional user interface corresponding to the additional user interface element.

15. One or more non-transitory computer readable media storing instructions that, when executed by one or more processors, cause the one or more processors to perform operations, the operations comprising:
receiving, based on an interaction with a user interface element of a user interface corresponding to a component of a data processing platform, a debug request associated with the component, the debug request comprising a component identifier (ID) corresponding to the component;
obtaining, from a log store and based on the component ID, error data associated with the component;
generating a prompt for a large language model based on the error data and metadata corresponding to the component; and
providing, by processing the prompt with the large language model, a debug output including natural language textual instructions displayable in a user interface corresponding to the user interface element.

16. The one or more non-transitory computer readable media of claim 15, the operations further comprising obtaining, based on the interaction, a context corresponding to the component, the context comprising the component ID and at least one of a component name or a product name of a product corresponding to the component.

17. The one or more non-transitory computer readable media of claim 16, wherein obtaining the context comprises obtaining the context based on an evaluation of user interface code used to render the user interface corresponding to the component.

18. A system, comprising:
one or more memories; and
one or more processors configured to execute instructions stored in the one or more memories to cause the system to:
receive, based on an interaction with a user interface element of a user interface corresponding to a component of a data processing platform, a debug request associated with the component, the debug request comprising a component identifier (ID) corresponding to the component;
obtain, from a log store and based on the component ID, error data associated with the component;
generate a prompt for a large language model based on the error data and metadata corresponding to the component; and
provide, by processing the prompt with the large language model, a debug output including natural language textual instructions displayable in a user interface corresponding to the user interface element.

19. The system of claim 18, wherein, to obtain the error data, the one or more processors are configured to execute the instructions to cause the system to:
generate a query corresponding to the log store;
provide the query to a search service configured to query the log store; and
retrieve, based on the query and via the search service, the error data from the log store.

20. The system of claim 18, wherein the one or more processors are configured to execute the instructions to cause the system to:
receive machine readable instructions from the large language model; and
facilitate, based on executing the machine readable instructions, an orchestration to perform one or more mitigation operations indicated by the debug output.
